(19) United States
(12) Patent Application Publication
(10) Pub. No.: US 2009/0191520 A1
(43) Pub. Date: Jul. 30, 2009

(54) Method and Apparatus for Word Forming and Word Building

(76) Inventor: Hareesh Viriyala, Gachibowli (IN)

Correspondence Address: Rahman LLC, 10025 Governor Warfield Parkway, Suite 110, Columbia, MD, 21044, US

(21) Appl. No.: 12/421,807

(22) Filed: Apr. 10, 2009

(30) Foreign Application Priority Data
Oct. 10, 2006 (IN) 2234/DEL/2006
Oct. 9, 2007 (IN) PCT/IN2007/000472

(51) Int. Cl. G09B 5/00

(52) U.S. Cl. 434/159; 434/169; 434/172

(57) ABSTRACT

A method of displaying alphasyllabaries by way of appropriately shaped building blocks that represent individual character components of the scripts, and an apparatus for Total word forming and word building in alphasyllabaries using a minimum number of such building blocks, such that orthographic accuracy of the words formed/built in relation to the script and conformity with the alphabetic-syllabic nature of the scripts are maintained. The method and apparatus include a structured means to house the building blocks in a sequence or grid of spaces, with each space comprising of a closed shape within a closed shape and capable of housing a simple syllable or a complex syllable. The inner closed shape typically houses an independent vowel or consonant, and the area between the inner closed shape and the outer closed shape typically houses the dependent characters (diacritics).

### CROSS-REFERENCE TO RELATED APPLICATIONS

This application claims priority to Indian application no. 2234/DEL/2006 filed on Oct. 10, 2006, and PCT application no. PCT/IN2007/000472 filed on Oct. 9, 2007, the disclosures of which, in their entireties, are herein incorporated by reference.

### DEFINITIONS

Alphasyllabaries or Alphabetic-Syllabic Scripts: Alphasyllabaries or Alphabetic-Syllabic scripts are writing systems in which consonant signs (graphemes) are inherently associated with a following vowel. Thus, the absence of such a vowel, or other following vowels, are usually indicated explicitly by means of diacritics that are before, after, above, or below the consonantal character or may surround it. Scripts of most South and Southeast Asian languages are alphasyllabaries. Outside South and Southeast Asia, the Ge'ez writing system of the Ethiopic language family (e.g., Amharic) is said to be an alphasyllabary.
Forming words: Generally refers to constructing a word made of a string of alphabets and/or syllables, using building blocks that depict various language characters, not necessarily building upon an existing word.
Building words: Constructing a new word made of a string of alphabets and/or syllables using building blocks that depict various language characters, by building upon an existing word by adding building blocks to the existing word, or by placing building blocks representing alphabets and/or syllables in a direction parallel or perpendicular to the existing word.
Total word forming and word building: Word forming and word building, not limited to board game play or interactive gaming, that uses building blocks depicting individual components of language scripts, takes into account every nuance and complexity of the script and language as perceived by a typical practitioner of the language(s) using a minimum number of building blocks, is linguistically accurate, in a frequency distribution similar or largely similar to commonly used written publications such as newspapers and magazines, through which virtually any word in the dictionary of the language concerned can be formed, and by which the words formed resemble the written script(s) as closely as possible.
Total building block-based word-building game in Hindi (and other Indian languages): A word building game, not limited to a board game or an interactive game, that uses building blocks depicting individual components (such as vowels, consonants, maatraas and ardhaakshars) of the scripts of Hindi (and other Indian languages), takes into account every nuance and complexity of the language as perceived by a typical practitioner of the language(s) using minimum number of building blocks, is linguistically accurate, that employs building blocks in a frequency distribution similar or largely similar to commonly used written publications such as newspapers and magazines, through which virtually any word in the dictionary of the language concerned can be formed, and by which the words formed resemble the written script(s) as closely as possible.
Apparatus: The word “apparatus” in this specification is used to mean “equipment designed to serve a specific function,” the specific function being able to achieve Total word forming and word building in Hindi and other alphasyllabaries. For example, in one embodiment where words are formed and built in crossword fashion through a game that is played on a board, “apparatus” refers to a board with a plurality of a square-within-a-square structure, plurality of tiles, and a plurality of tile racks collectively that allow playing of the game as disclosed. In another embodiment where words are formed and built on a frame, “apparatus” refers to a frame consisting of a plurality of a square-within-a-square structure and plurality of tiles, and one or more tile racks collectively that allow playing of the game as disclosed.
Board Game: A mind game that involves a game board and any, all, or any combination of the following: Tokens, building blocks, tiles, cards, dice, etc, and that typically does not involve physical exertion and is typically played indoors by two to six players.
Diacritic: A diacritic is typically a mark added to a letter to modify the phonetic meaning of a language character. In alphasyllabaries, a vowel diacritic is a secondary form of an independent vowel, and a consonantal diacritic is a secondary form of an independent consonant. Diacritics may also occur as primary forms in the form of vowel modifiers, but are dependent on consonants for their usage.
Interactive Gaming: A game played between a player and an electronic device (online or offline), or between two or more players using an electronic device, involving electronic/digital formats, and involving but not limited to computers, gaming consoles, TV screens and computer monitors, and/or mobile phones.
Meaningful board game play: A board game that entertains, educates, challenges, provides fun and/or excitement, requires a reasonable amount of intellect, sharpens the mind, is a tool for socializing, relieves stress, improves decision making capabilities, simulates real-world situations, etc, or is any combination of or all of the above, and that can be completed typically in less than four hours of total playing time.
Meaningful Interactive Gaming: A video game that entertains, educates, challenges, provides fun and/or excitement, requires a reasonable amount of intellect, sharpens the mind, is a tool for socializing, relieves stress, improves decision making capabilities, simulates real-world situations, etc, or is any combination of or all of the above, and that can be completed typically in less than four hours of total playing time.
Non-linear: When alphasyllabaries are broken down into their components—vowels, consonants, and diacritics—the scripts become “non-linear” i.e., the diacritics occur above and below the consonant they belong to in addition to occurring before and after the consonant.
South and Southeast Asian languages: Most South and Southeast Asian languages have a common feature in the morphology of their scripts, where the vowels are written in their independent form, or by using a variety of diacritics that are written before, after, above or below the consonant they belong to. The said languages include but are not limited to Hindi, Marathi, Gujarati, Nepali, Sanskrit, Sindhi, Pali, Sanskrit, Bhojpuri, Bengali, Oriya, Assamese, Kashmiri, Punjabi, Tamil, Telugu, Kannada, Malayalam, Sinhala, Lao and Thai.
Devanagari script: The script used to write languages that include but are not limited to Hindi, Marathi, Sanskrit, Nepali, Nepal Bhasa, Maithili, Konkani, Sindhi, Pali, Bhojpuri, Marwari, Bhili, Bihari, Tharu, Kashmiri (sometimes) and Romani.
The definitions of the basic characters that represent the characters of the Hindi language are explained herein:
Svar: The vowels of the “alphabet”, comprising of A AÉ C D E F G L Lå AÉå AÉæ. The diacritics [symbol] ü and È were traditionally included in the list of vowels, but are now categorized as anusvaar and visarg respectively.
Vyanjan: The consonants of the “alphabet”, comprising of the following:
Mü ZÉ aÉ bÉ Xû
cÉ Nû eÉ fÉ gÉ
Oû Pû Qû Rû hÉ
iÉ jÉ S kÉ IÉ
mÉ Tü oÉ pÉ qÉ
rÉ U sÉ uÉ zÉ wÉ xÉ Wû
ÄQû ÄRû (The last two are derived from Qû and R by placing a diacritic symbol (.) below the consonants)
Samyukt Vyanjan: Conjunct consonants. The four conjunct consonants that are part of the Hindi “alphabet” are [symbol] É §É ¥É and ´É.
Ardhaakshar: A “half consonant” derived from a consonant, which is used in forming conjunct consonants. For example: c, Oè, Sè, and x. Examples of words that incorporate these ardhaakshars are AcNüÉ, sÉOèOÕû, mÉSèqÉ, and xqÉUhÉ.
Maatraa: A diacritic representing a vowel and used along with a consonant to modify the phonetic meaning of the consonant. The maatraas, comprise the following:
É Í [symbol] Ñ Ô×å æ Éå üÉæ

The diacritic [symbol] ü, known as chandrabindu, also gives a nasal sound as the anusvaar ( [symbol] ü). The diacritic [symbol] known as ardhchandra, is the latest entrant into the Hindi language and is used to accommodate the “aw” sound of certain words (e.g., college, form) in the English language that have now become part of the Hindi language.

For example, when the maatraas, anusvaar, visarg and chandrabindu are applied to the consonant Mü, the phonetic meaning of the consonant changes as follows:
MüÉ ÌMü Mü [symbol] MÑü Måü Mæü MüÉå MüÉæ M [symbol] ü MüÈ and M [symbol] ü
Foreign sounds accepted in Hindi: Sounds such as ÄeÉ (za) and ÄTü (fa) that are now accepted in Hindi.
Samyuktaashar: A compound consonant formed by the combination of two or more consonants.
Neeche bindi/Nuktaa: The dot below some of the consonants used to modify the sound of the consonants.
Vowel modifiers: Diacritics that are not secondary forms of vowels but can change the phonetic meaning of a consonant. Examples are the anusvaar, chandrabindu, visarg, and ardhachandra in Devanagari.
Simple syllable: Each vowel and consonant in an alphasyllabary is a “segment” and an inherently simple syllable. A combination of an inherently simple syllable and a vowel diacritic or vowel modifier gives rise to another simple syllable with a different phonetic meaning.
Complex syllable: The combination of two consonants (with or without a vowel diacritic or vowel modifier).

### TECHNICAL FIELD

The invention generally relates to word forming and word building method and apparatus. More specifically, the invention relates to method of displaying characters of, and word forming and word building apparatus for Hindi and other alphabetic-syllabic languages while maintaining the orthographic accuracy of the scripts and conforming to the alphabetic-syllabic nature of the language scripts.

### BACKGROUND AND PRIOR ART

Word games, which form an important category of the various indoor games that exist today, have utility in education and entertainment in the form of educational and teaching aids; and entertaining, competitive, and challenging games. The benefits of such games are language and vocabulary building, intellect development, fun and excitement, improving decision making and strategic thinking skills, and enhancing creativity through creative word play. Such games also aid in social interaction and stimulate excitement about words and languages.

Word play in the English language has existed for centuries in the form of anagrams, riddles, acrostics, palindromes, word grids, pangrams, etc. Several word games in English and other Roman alphabet-based languages exist in the market in the form of crossword puzzles (published by numerous publishers); Board Games such as Word Plus, Scrabble, Speller, Grab a Word, and Boggle; Electronic Interactive Games, both computer-based and mobile phone-based, such as Literati, Word Racer, Spelvin, Word Mojo, Book Worm, Word Challenger, Infinite Crosswords; and Educational/Teaching aids that also include some of the above mentioned games. Word games in these languages exist in various forms, some of which are: card-based games, dice-based games, and building block-based games, wherein letters or groups of letters are written/printed on the cards, on the faces of the dice (standard six-side dice, tetrahedron shaped, or any other shape), and on the building blocks, and players form words by placing the cards, exposed faces of the dice, and building blocks next to each other. Building block-based word building games in Roman alphabet-based scripts (e.g., English, Spanish, French), which are alphabetic in nature with vowels and consonants strung next to each other (some vowels and consonants in these languages, except English, have diacritics such as umlaut in German and grave in French), have existed for decades and perhaps even centuries. Several of the aforementioned word games are building block-based, whether in the physical or electronic forms.

One reason for the existence of such a multitude of building block-based word games in Roman alphabet-based scripts (henceforth also termed as Latin scripts in this application) is the very nature of the Latin script, which lends itself nicely to such word play. Each alphabet is represented on the face of a building block and even those alphabets that have diacritics are represented on the face of a building block, with both the underlying alphabet and the diacritic being included within the same face of the building block. It must be noted here that even though the standard way of writing Latin scripts is in a left-right direction, words are very recognizable even when the alphabets of the words are written in a top-down direction. In fact, such a top-down display format is frequently used in outdoor signage.

Alphabetic-syllabic language scripts (or Alphasyllabaries) (such as those of South and Southeast Asia) are generally more complex than Latin scripts. The English language (Latin script), for example, is based on 26 letters—21 consonants and 5 vowels; but the Hindi language (a language native to North India and that employs the Devanagari script), for example, is based on 33 distinct consonants, 4 conjunct consonants, 11 vowels and 10 diacritics derived from these vowels, 4 vowel modifiers, at least three accepted consonants of foreign origin, and 35 “half consonants” (consonantal diacritics). Each character (vowel or consonant or vowel modifier) in the “alphabet” of an alphasyllabary is essentially a “segment” or a primary form, with the vowels and consonants being (inherently) simple syllables, and with each consonant (segment) having the first vowel of the “alphabet” inherent to it. In the absence of the inherent first vowel of the “alphabet”, each consonant would become a pure consonant. A peculiar feature of Hindi and other alphasyllabaries is that when a pure consonant combines with a vowel, resulting in a new syllable (another simple syllable), the consonant retains its primary form, but the vowel transforms into a totally different looking character, the vowel diacritic, which is an allograph to the vowel and can be termed as a secondary form (a vowel and its diacritical form represent the same sound, but are visually represented by different characters depending on whether the vowel is in its independent form or in combination with a consonant; Table 1 illustrates the primary difference between consonant-vowel combinations in Latin scripts and in an alphabetic-syllabic script such as Devanagari). Another peculiar feature of Hindi is that when two or more consonants combine, one of three situations can arise: One, the consonants transform into one contextually acceptable conjunct consonant; two, the leading consonants are represented as “half consonants” (only the essential portions of the leading consonants are taken and attached to the final consonant); or three, a diacritic mark is added below each of the leading consonants to mute the inherent vowel, transforming the leading consonants into “half consonants” or consonantal diacritics. The “half consonants” or consonantal diacritics (which can also be termed as secondary forms) are essentially the only pure consonants in the script, because the inherent vowel is muted. Also, a combination of two consonants (with or without a vowel diacritic or a vowel modifier) gives rise to a new complex syllable. The above mentioned features are applicable to scripts across South and Southeast Asia.

TABLE 1
Consonant-Vowel Combinations
(W is the primary form and Wè is the dependent consonant
or secondary form, sans the inherent vowel)

| Latin Script | Devanagari Script |
|---|---|
| H + I = HI | Wè + C = ÌWû (vowel = C; vowel diacritic = Í) |
| H + U = HU | Wè + E = WÒû (vowel = E; vowel diacritic = Ñ) |
| H + E = HE | Wè + L = Wåû (vowel = L; vowel diacritic = å) |

APPENDIX A shows a comparison of the characters that make up the scripts of the English and Hindi languages. For the purpose of this application, examples are illustrated using English and Hindi, and where possible, Telugu (a language native to South India and that employs the Telugu script). Language scripts native to South and Southeast Asia are structurally similar in nature to the Devanagari script (for e.g., vowels are represented as both independent or as dependent characters; and the vowel diacritics, which are allographs (secondary forms) to the vowels themselves, occur before, after, above or below the consonants they are associated with). In fact, such structural similarity is common even to alphasyllabaries that are not native to South and Southeast Asia. These language scripts are also “non-linear” when are broken down into their individual components such as vowels, consonants, vowel diacritics, vowel modifiers and “half consonants”, because the latter three, (which are separable from the consonants) can occur before, after, above or below the vowels and consonants they are associated with.

One main difference between diacritics of Latin scripts and alphabetic-syllabic scripts is that in the former, alphabets with diacritics are either separate alphabets or variants of the underlying alphabets, with the diacritics being part of the alphabets; whereas diacritics in the latter are separate entities representing other segments and are part of the syllables they form when combining with consonants. Thus, the diacritics of the latter are essentially secondary forms of vowels and consonants (allographs of the segments they are representing) and juxtaposed to consonants in one or more of four zones (before, after, above, and below) relative to the consonants they are associated with. In most cases, the spread of the diacritic is restricted to one zone. However, in some cases, the diacritic spreads across two or more such zones. FIG. 1 shows examples of vowel diacritics of Hindi and the zones that they occupy.

FIG. 2 illustrates a comparison of display components for Latin characters, Devanagari characters, and Telugu characters using components shaped in the form of the characters themselves to represent the same word ‘CRICKET’. Such display components (typically made of metal, plastic, or wood) are used commonly, for example, on name plates. Because diacritics (both vowel and consonantal) in alphasyllabaries are juxtaposed to consonants to form new syllables, they are “bound” or “attached” to the consonant, with the result that when the individual character components are displayed top-down, the word is not recognizable (FIG. 3). An added limitation manifests when trying to form words crossword style (FIG. 4 shows the word ‘WICKET’ being formed in crossword style with the existing word ‘CRICKET’). Thus, the multitude of diacritics and the positions they occupy relative to the consonants introduces complexities in displaying the script using individual character components, especially in a top-down writing format. In Latin scripts, alphabets are separated from each other when written in a top-down format with the resultant words being very recognizable. However, in alphabetic-syllabic scripts, the diacritics are never separated from the consonants they are associated with when written in a top-down format, because it would go against the very nature of the script: That words are strings of segments/syllables and pure consonants strung to each other. For the aforementioned reasons, not the least of which is the fact that in alphasyllabaries, the diacritics are bound to the consonants and are part of syllables, crossword puzzles in these languages have syllables (either simple or complex) in each cell. FIG. 5 illustrates the fundamental difference between crossword puzzles in a Roman alphabet-based language such as English and an alphabetic-syllabic language such as Hindi and Telugu. When the display components shaped in the form of the characters themselves are arranged in accordance to the alphabetic-syllabic nature of the scripts, words are recognizable when formed in a top-down format, and therefore compatible with crossword style word building (FIG. 6).

However, such a method of displaying characters has several limitations when it comes to representing individual character components of alphasyllabaries using building blocks. Not only does compatibility with crossword formation take a hit, issues such as orthographic accuracy (reasonable accuracy in comparison to the actual script) arise when the building blocks are placed even in a left-right format. In contrast, there are no such problems in representing individual alphabets of Latin scripts using building blocks, even in crossword style word formation (FIGS. 7A and 7B). Even with those alphabetical languages that use diacritics, there are no such problems because the diacritics are part of the alphabets themselves and represented on the same face of the building block as the underlying alphabets. To illustrate this point, consider the diacritics in German and Czech. Contemporary German has three alphabet variants that have umlauts (Ä, Ö, and Ü), derived from the underlying alphabets A, O, and U. Czech also has alphabets with diacritics (e.g., \check{C}, É, \check{E}, \check{S}, Ú, \check{Z}), but these alphabets are separate alphabets in themselves. FIG. 8 illustrates various alphabets in both languages represented on faces of building blocks and the compatibility with orthographic accuracy and crossword style word formation. FIG. 9 illustrates how the building blocks would have been if the diacritics were separated. A user wouldn't be able to form a word using the diacritics in a left to right direction, because then orthographic accuracy would be rendered meaningless. However, this situation does not arise because it is linguistically inaccurate to separate the diacritic from its underlying alphabet and represent it separately in another building block because the diacritic is part of the alphabet itself.

This conduciveness of Roman alphabet-based languages and alphabetical script languages with building block kind of word play is highlighted in the popular word game Scrabble (registered trademark), which employs crossword style word formation and word building. First produced more than 56 years (at the time of this application) in English, other language versions (e.g., French, German, Swedish, Czech) were gradually added to arrive at the current number of 31. The more recent language versions of the game include Hungarian, Slovenian, Croatian, Russian, Hebrew, and Arabic, of which the former three employ Roman alphabet-based scripts, and the latter three employ Cyrillic, Hebrew, and Arabic scripts respectively. Cyrillic is an alphabetical script and therefore words comprise of vowels and consonants strung next to each other. Contemporary Hebrew and Arabic scripts are written with few or no diacritics with the result that they can be depicted in an alphabetic way by minimizing or eliminating the diacritics, by building blocks that can be strung together in a linear fashion to form words.

Thus the few diacritics that might be needed in these languages are represented along with the underlying alphabets on the same face of the building blocks, thereby enabling compatibility with crossword style word play without loss of orthographic accuracy. The small number of the different alphabets and alphabet variants, each of which can be represented on the same face of a building block, and the resulting compatibility with crossword style word formation and word building makes it possible to have Total word forming and word building.

In other words, Total word forming and building makes it conducive to have Total educational aids and meaningful board game play and interactive gaming. Even the popular online game Literati employs similar building blocks (virtual form) and offers versions in a variety of languages based on alphabetical scripts. Other patented games involve building blocks in alphabetical scripts (especially Latin scripts). U.S. Pat. No. 4,690,410 describes a word forming game using tiles, with each tile representing an alphabet of the English language or other Roman alphabet-based languages. U.S. Pat. No. 5,407,355 describes display components to represent characters of the Arabic script, but in the shape of the language characters themselves. It must be noted here that each building block-based word game in Latin scripts employs building blocks that are homogenously shaped.

Contrary to the numerous available alphabetical language word games in the market and abundant literature on such games, word games in alphasyllabaries (such as those of South and Southeast Asia) and relevant literature are very rare. Crossword puzzles in alphabetic-syllabic languages (including Hindi) that are published in the print media are a relatively new phenomenon, presumably drawing upon the concept of English crossword puzzles, whose current form originated in the first quarter of the 20^{th} century and whose popularity grew manifold ever since. Word games in alphasyllabaries including word building games in unorganized formats are sometimes used in education. Some of these formats include filling in the blanks of a word with the appropriate language character; and writing language characters on cards or paper pieces or building blocks, distributing among students and facilitating word formations using the characters on the cards/paper pieces/building blocks. Such card or paper pieces-based games do not take into account all the complexities and nuances of the languages and do not facilitate forming virtually any word in the dictionary using a minimum number of cards/paper pieces/building blocks.

Because alphasyllabaries are alphabetic-syllabic in nature, words are formed by syllables and alphabets strung to each other. A wide variety of complex syllables are used very frequently in these languages, and given that a consonant (inherently simple syllable) can combine with each vowel and even other consonants in a variety of ways to yield a variety of complex syllables, the number of complex syllables possible and in usage is very large (several hundred to thousands). For example, each consonant in Hindi can combine with each of the vowels to generate a different syllable, resulting in over 500 syllables (of which at least 250 find their way in regular use). In addition, there are several other complex syllables that result from the combination of two or more consonants and the combination of such conjunct consonants with vowels. Technically speaking, the number of syllables that are possible is in excess of 2000. If one were to design a building block-based word forming or word building educational aid or game by mapping each possible syllable (simple and complex) onto one building block and take into account the frequency with which they occur in the language, the designer would need to employ at least several hundred building blocks to cover all the complexities and nuances of the language and to be able to form virtually any word in the dictionary, thereby making it impossible to design a Total word forming or word building educational aid or game that is practical (to manufacture or use) or that is conducive to meaningful board game play and meaningful interactive gaming.

One way to counter this large number of building blocks required is by breaking down the scripts into their components. But due to the very nature of the script (e.g., the vowel diacritics are bound to the consonants they are associated with and occupy one of the four zones and sometimes even spread across multiple zones (described in FIG. 1); the script is non-linear when broken down into its constituent characters), retaining the orthographic accuracy of the script is a challenge in itself. For the same reason, because some vowel diacritics “wrap around” the consonant, the diacritics cannot simply be placed adjacent to the consonants they are associated with, contrary to the way vowels and consonants can be placed adjacent to each other in building block based word forming and word building in alphabetical scripts. In addition, the diacritics still raise problems for crossword style play. This problem doesn't arise in alphabetical scripts, since each alphabet is independent of the other (and not “attached”) and orthographic accuracy is not an issue when the alphabets are written top-down or left-right. Thus, traditional building blocks, which are homogenously shaped for the purpose of word forming and word building in alphabetical scripts, do not make sense for alphabetic-syllabic scripts.

Therefore, if syllables in alphasyllabaries are not split into individual units, as discussed, the number of syllables to be mapped to corresponding building blocks will be too many to design a Total word forming or word building educational aid or game that is practical (to manufacture or use) or that is conducive to meaningful board game play and meaningful interactive gaming. And, if the syllables are split and used, then the number of required building blocks is within manageable limit, but orthographic accuracy cannot be maintained.

One educational and entertaining word building game available in the market is Talimi Tash, a card-based word game in Urdu, now a widely used language in South Asia. The game involves forming words out of Urdu language characters written on a set of playing cards, each of which has an alphabet or a language character written on it. Each player is dealt a certain number of playing cards with which s/he has to form words. Cards are either stacked on top of each other or placed adjacent to each other to form words. It must be noted that the Urdu language employs the Arabic script, which is conducive to Total word building for the aforementioned reasons. There is no such card-based word building game in Hindi or other alphabetic-syllabic languages available in the market, at least as far as a Total word building game is concerned. Also, there is no building block-based word game in Hindi or other alphasyllabaries that depicts the languages using building blocks of assorted shapes, and there is no Total building block-based word game in Hindi or other alphasyllabaries.

Thus, there is a need for Total word forming and word building educational aids and games where people can participate in word building exercises in the said languages while maintaining orthographic accuracy and alphabetic-syllabic conformity, and derive the aforementioned benefits.

### REFERENCES

The following link provides the standard for the Devanagari script and the Roman transliteration followed herein: http://www.unicode.org/charts/PDF/U0900.pdf

It must be noted that not all characters of the Devanagari script (which is also used to write languages other than Hindi) that are mentioned in the aforementioned chart are used in Hindi. APPENDIX A illustrates the characters used in the English language and the Hindi language.

### OBJECTS AND SUMMARY OF THE INVENTION

The terms “building blocks” and “tiles” are used interchangeably throughout this application.

Thus, it is a general object of the invention to provide a method of displaying alphasyllabaries by way of building blocks representing individual character components of the scripts, such that orthographic accuracy and conformity with the alphabetic-syllabic nature of the scripts are maintained, even when words are represented in a top-down format. The object is achieved through building blocks that are appropriately shaped.

Another general object of the invention is to provide a method of displaying alphasyllabaries in a structured manner, by way of building blocks representing individual character components of the scripts, organized in a structured means with each constituent of the structured means capable of housing a simple syllable or a complex syllable, similar to the way each cell in a crossword puzzle functions, so as to always maintain orthographic accuracy and conformity with the alphabetic-syllabic nature of the scripts. The object is achieved by way of a plurality of spaces, with each space being a shape within a shape, with the inner shape typically housing a simple syllable (vowel or consonant), and the area between the inner shape and the outer shape housing the dependent characters (vowel and/or consonantal diacritics). The shape is any suitable closed shape in the form of any polygon.

Another object of the invention is to facilitate construction, modification and deconstruction of words by adding, substituting, and/or removing building blocks representing individual character components, so as to enable creative word play within the morphological rules of the scripts, while maintaining orthographic accuracy and conformity with the alphabetic-syllabic nature of the scripts.

Another general object of the invention is to facilitate Total word forming and word building in Hindi and other alphasyllabaries for use in educational and teaching aids, creative word play, and meaningful board game play & interactive gaming.

This object is achieved by way of an apparatus, where apparatus includes:
assorted-shaped building blocks in separate pools, categorized by the functions that the characters they are representing have in the scripts—a pool of main tiles (independent vowels and consonants), pools of special/dependent tiles (vowel diacritics and consonantal diacritics), with each of these pools having all its constituent building blocks of a homogenous shape;
a pool of reserve tiles containing tiles that represent single-unit conjunct consonants that cannot be depicted using constituent building blocks from the other pools tiles, tiles that replace tiles from the main and special pools with equivalent characters (to maintain orthographic accuracy and the alphabetic-syllabic nature of the scripts), and tiles that act as modifiers (to take into account the complexities and nuances of the scripts/languages); and
a structured means to place tiles.

Another object of the invention is to enable Total word forming and word building in Hindi and other alphasyllabaries.

This object is achieved by way of an apparatus, where apparatus includes:
assorted-shaped building blocks in separate pools, categorized by the functions that the characters they are representing have in the scripts—a pool of main tiles (independent vowels and consonants), pools of special/dependent tiles (vowel diacritics and consonantal diacritics);
an additional pool of tiles that represent single-unit conjunct consonants that cannot be depicted using constituent building blocks from the other pools, and tiles that act as modifiers (to take into account the complexities and nuances of the scripts/languages); and
a structured means to place the building blocks.

Still another object of the invention is to provide racks that are conducive for placing and managing the tiles.

One more object of the invention is to facilitate standardization of written Hindi and other alphasyllabaries because of the different conventions used by various groups such as governing bodies related to the teaching and promotion of the languages, academia, media, and members of the public in the usage of certain characters of the languages.

Accordingly, the present invention provides a method of displaying alphasyllabaries using appropriately shaped building blocks that represent the individual character components of the scripts, such that orthographic accuracy and conformity with the alphabetic-syllabic nature of the scripts are maintained even when words are displayed in a top-down format. The invention further provides an apparatus for Total word forming and word building for use in educational aids and creative word play, wherein the apparatus includes building blocks categorized by the functions that the characters they are representing have in the scripts, and a structured means to place the building blocks, with each space comprising of a closed shape within a closed shape and capable of housing a simple syllable or a complex syllable.

In one embodiment, the invention provides appropriately shaped building blocks that represent individual character components, such that the words formed using the building blocks maintain orthographic accuracy and conformity with the alphabetic-syllabic nature of the language scripts under consideration.

In another embodiment, the invention provides a structured means to house the building blocks, said means comprising of a plurality of spaces, with each space being a closed shape within a closed shape.

In another embodiment, the invention provides a game consisting of a 15×15 or 17×17 spaces game board grid for placing tiles for forming and building words, pools of tiles, and a rack for placing and managing the said tiles. Each space forming the grid of the said board is a closed shape within a closed shape. The main tiles are intended to be placed in the inner closed shape of a space and the special tiles are intended to be placed in the area between the inner and outer closed shape of a space. Each space can accommodate any or a combination of a consonant, an independent vowel, a vowel diacritic, a consonantal diacritic, or an accepted form of a conjunct consonant. A combination of such syllables and alphabets forms words in both horizontal and vertical directions on the said board. Also provided is a multi-level rack to place and manage the tiles while forming words.

In another embodiment, the invention provides a frame comprising of rectangular grid of spaces in the form of slots for forming and building words.

In one another embodiment, the invention provides a rack that has 8 spaces (ridged) adjacent to each other in a single row for forming words.

The aspects and embodiments of the present invention will be apparent from the following description when read in conjunction with the accompanying drawings. It is to be understood that both the foregoing general description and the following detailed description of the embodiments of the present invention, are intended to provide an overview for understanding the nature and character of the invention as it is claimed and not restricted to the languages and medium used in the description and drawings.

### BRIEF DESCRIPTION OF THE DRAWINGS

For the purpose of this application, Hindi (a north Indian language written in the Devanagari script), and where possible, Telugu (a south Indian language written in the Telugu script) are used to cite examples of alphasyllabaries.

FIG. 1 illustrates the zones that vowel diacritics occupy in the Devanagari script.

FIG. 2 illustrates a comparison of display components of Roman alphabet characters, Devanagari characters, and Telugu characters using components shaped in the form of the characters themselves.

FIG. 3 illustrates how words in Devanagari and Telugu are not recognizable when the individual character components are displayed in a top-down format.

FIG. 4 illustrates the added problems when trying to build words in crossword fashion when the individual character components are separated from each other.

FIG. 5 illustrates the fundamental difference between crossword puzzles in a Roman alphabet-based language such as English and an alphabetic-syllabic language such as Hindi and Telugu.

FIG. 6 illustrates how words of alphasyllabaries are recognizable when formed in a top-down format, and therefore compatible with crossword style word building when the display components shaped in the form of the characters themselves are arranged in accordance to the alphabetic-syllabic nature of the scripts.

FIGS. 7A and 7B illustrate the incompatibility with crossword formation when words are formed by building blocks that represent individual character components and issues in orthographic accuracy even when the building blocks are placed even in a left-right format.

FIG. 8 illustrates various alphabets in German and Czech languages represented on faces of building blocks and the compatibility with orthographic accuracy and crossword style word formation.

FIG. 9 illustrates how the building blocks would have been if diacritics in German and Czech were separated.

FIG. 10 illustrates appropriately shaped and efficiently sized building blocks representing individual character components of the Devanagari script.

FIG. 11 illustrates a method of displaying the Devanagari script, by way of appropriately shaped building blocks representing the individual character components of the scripts, so as to maintain orthographic accuracy and conformity with the alphabetic-syllabic nature of the script.

FIG. 12A illustrates a building block representing a vowel diacritic in the Telugu script that is of a different shaped than building blocks used in displaying Devanagari.

FIGS. 12B and 12C illustrate shapes other than squares and rectangles can be used to represent the language characters and scripts.

FIG. 13A illustrates a structured means to house the building blocks representing individual character components of Devanagari.

FIG. 13B illustrates building blocks described in the first embodiment organized in the said means according to the morphological rules of the script.

FIG. 14 illustrates alternate structured means and method of displaying Devanagari.

FIG. 15 illustrates a part of the board containing the space for placing the tiles.

FIG. 16 illustrates a tile.

FIG. 17 shows the main tiles.

FIG. 18 shows the Maatraa tiles.

FIG. 19 shows the Ardhaakshar tiles.

FIG. 20 shows the Reserve tiles.

FIG. 20A illustrates an example for using Reserve tiles.

FIGS. 21 A, B and C show the examples for the placement of the tiles to form a word

FIG. 22 shows a method of forming word from an existing word.

FIGS. 23 A and B show yet another method of forming a word from an existing word.

FIG. 24 shows yet another method of forming a word from an existing word.

FIG. 25 shows yet another method of forming a word from an existing word.

FIG. 26 shows methods of placing an Ardhaakshar tile.

FIG. 27 shows a method of placing a Maatraa tile.

FIG. 28 illustrates an exceptional case of placing a Main tile.

FIG. 29 illustrates yet another exceptional case of placing a Main tile.

FIG. 30 illustrates a case of exchanging a tile.

FIG. 31 illustrates the front and side view of the rack.

FIG. 32 shows the second embodiment for an apparatus used for easy placement of tiles using L-shaped guides.

FIG. 33 shows the three dimensional view of the second embodiment for an apparatus used for easy placement of tiles using L-shaped guide along with a single space.

FIG. 34 shows the second embodiment for an apparatus used for easy placement of tiles using straight line guides.

FIG. 35 shows the three dimensional view of the second embodiment for an apparatus used for easy placement of letters using straight line guide along with a single space.

FIG. 36 shows the first case of the third embodiment for an apparatus in the form of a frame that has 6 to 8 spaces adjacent to each other in a single row for forming words.

FIG. 37 shows the three dimensional view of the first case of the third embodiment comprising a single outer square (1501) along with a straight line guide (3401) for easy placement of letters.

FIG. 38 shows the second case of the third embodiment for an apparatus in the form of a frame that has 6 to 8 spaces adjacent to each other in a single row for forming words.

FIG. 39 shows the three dimensional view of the second case of the third embodiment comprising of a single outer square (1501) along with a L-shaped guide (3201) for easy placement of letters.

FIG. 40 shows an example of the virtual interface of the game.

FIG. 41 illustrates the five “zones”—centre, left, right, top and bottom—to which individual script components are assigned to, based on the position they occur in the script, relative to the vowel or consonant they are associated with.

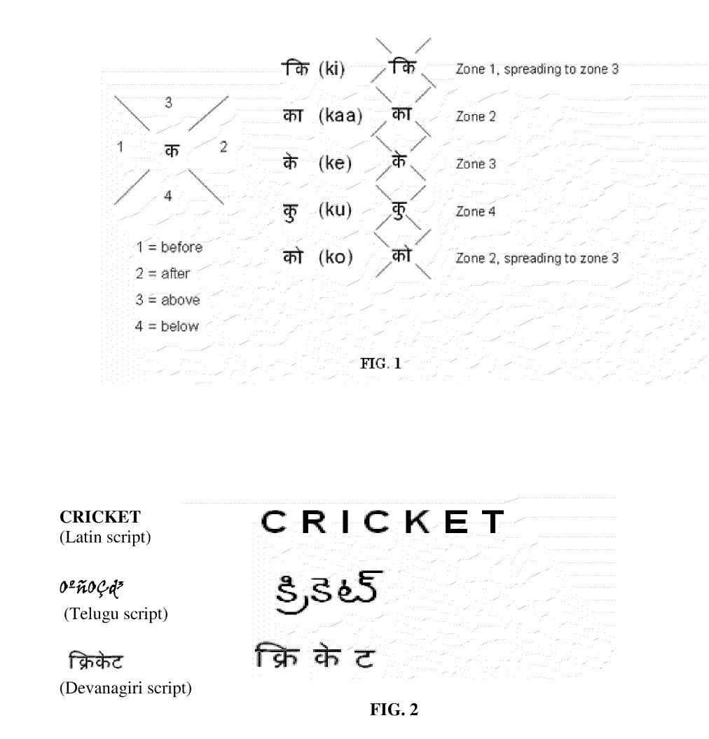

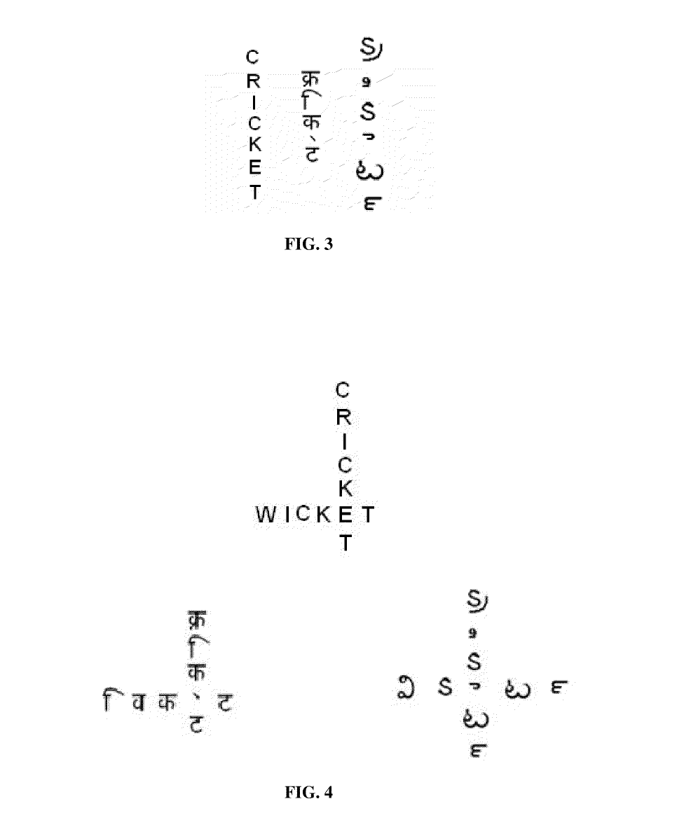

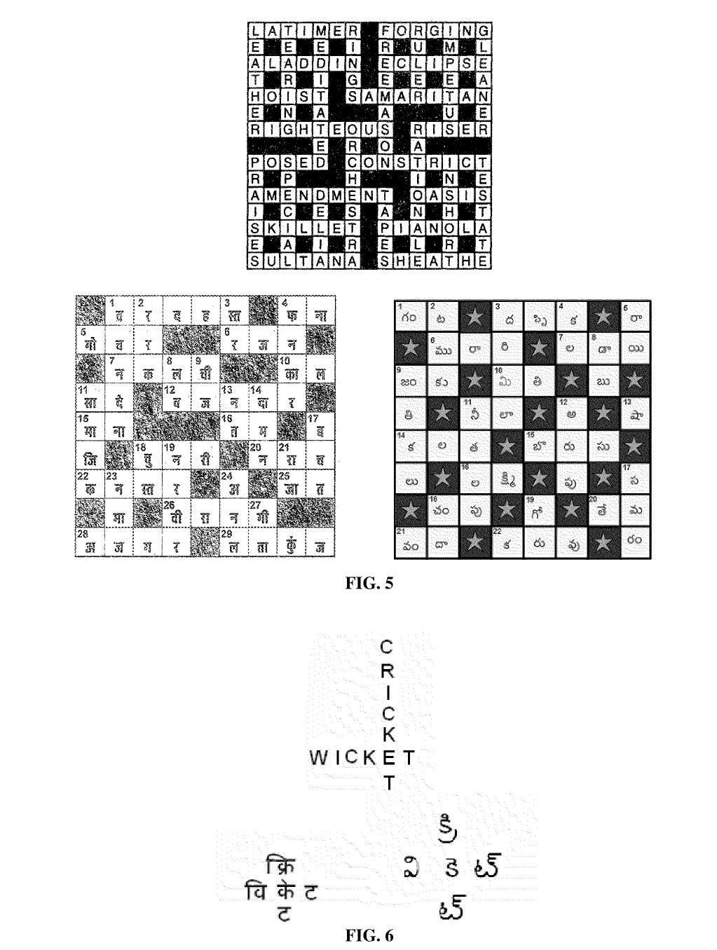

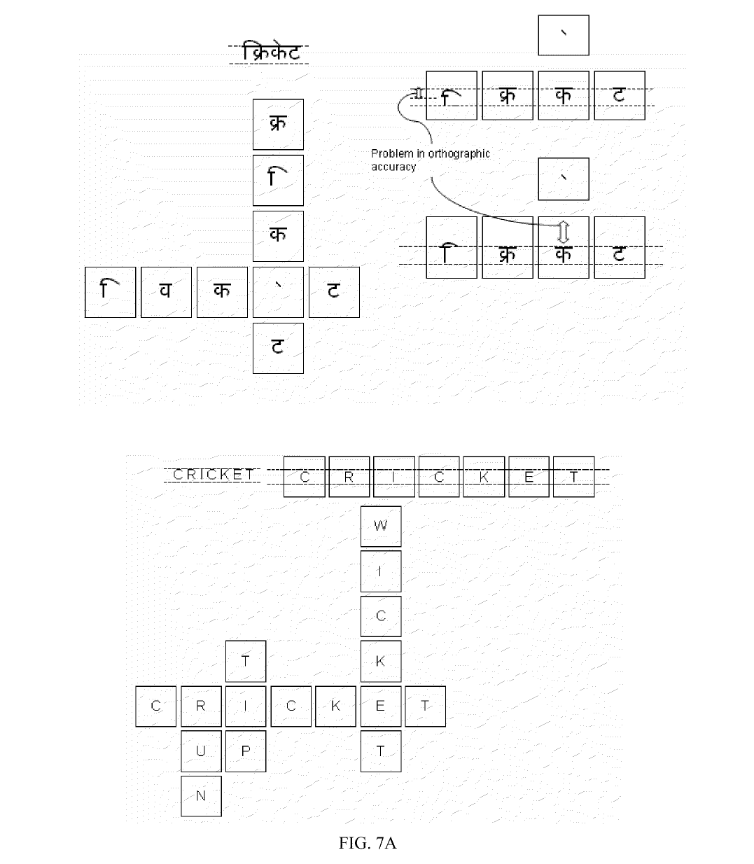

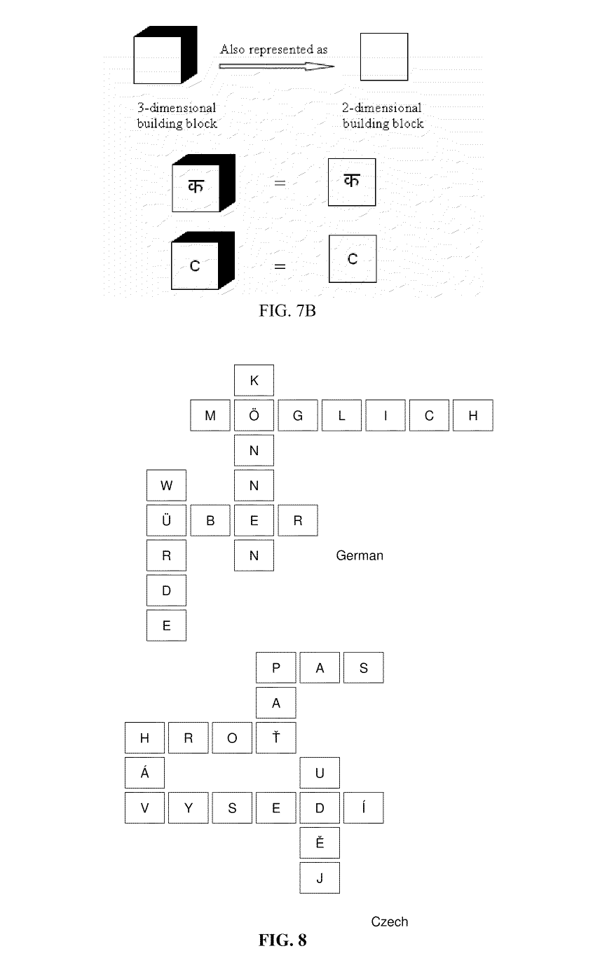

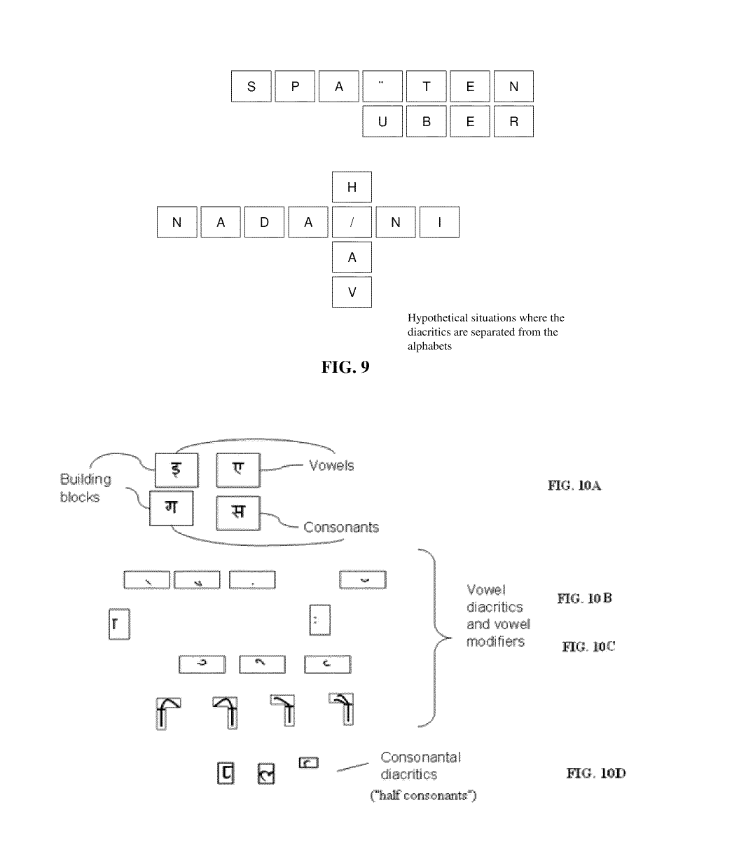

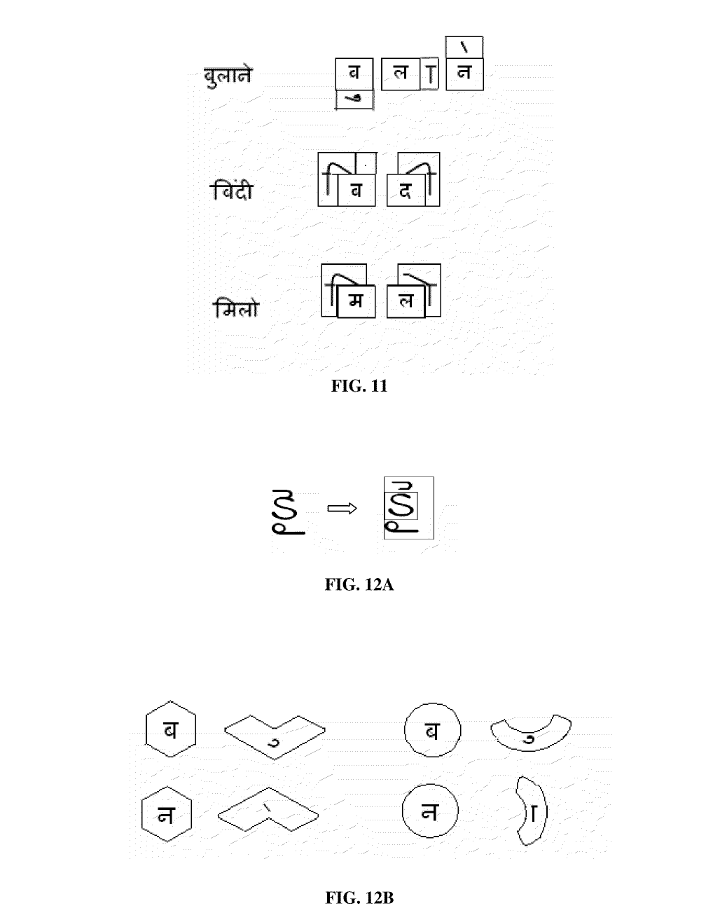

### DETAILED DESCRIPTION OF THE INVENTION

### Building Blocks of Appropriate Shapes

FIG. 10A shows building blocks representing independent vowels and consonants, each square in shape.

FIG. 10B shows building blocks representing vowel diacritics and vowel modifiers, each rectangular in shape.

FIG. 10C shows building blocks representing vowel diacritics, each L-shaped.

FIG. 10D shows building blocks representing consonantal diacritics (half consonants), each rectangular in shape.

Such building blocks could be tangible and three-dimensional in nature (made of, say, wood or plastic) or represented in electronic format on a computer screen or hand-held device. Thus, this way of displaying characters is true for all media (physical, electronic, print).

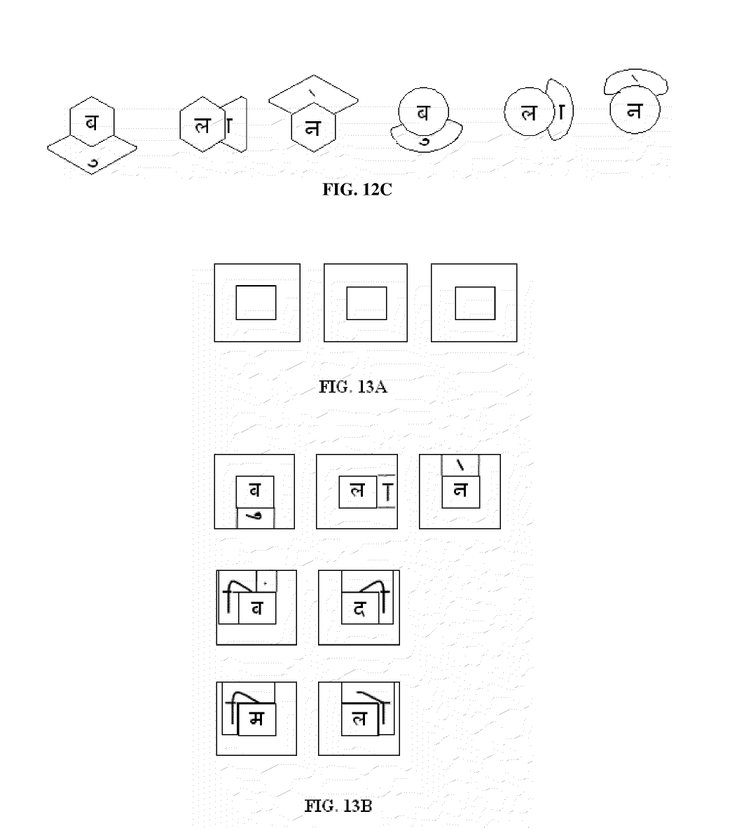

In general, the shapes and relative sizes of the building blocks should not be construed in a limiting sense. For e.g., For example, the vowel diacritic signifying the “ai” sound in Telugu is represented by two symbols separated from each other, one above and one below the consonant it is associated with. Such a diacritic would warrant a shape as shown in FIG. 12A (U-shaped); and shapes other than squares and rectangles can be used to represent the language characters (FIGS. 12B, C).

Closed Shape within a Closed Shape

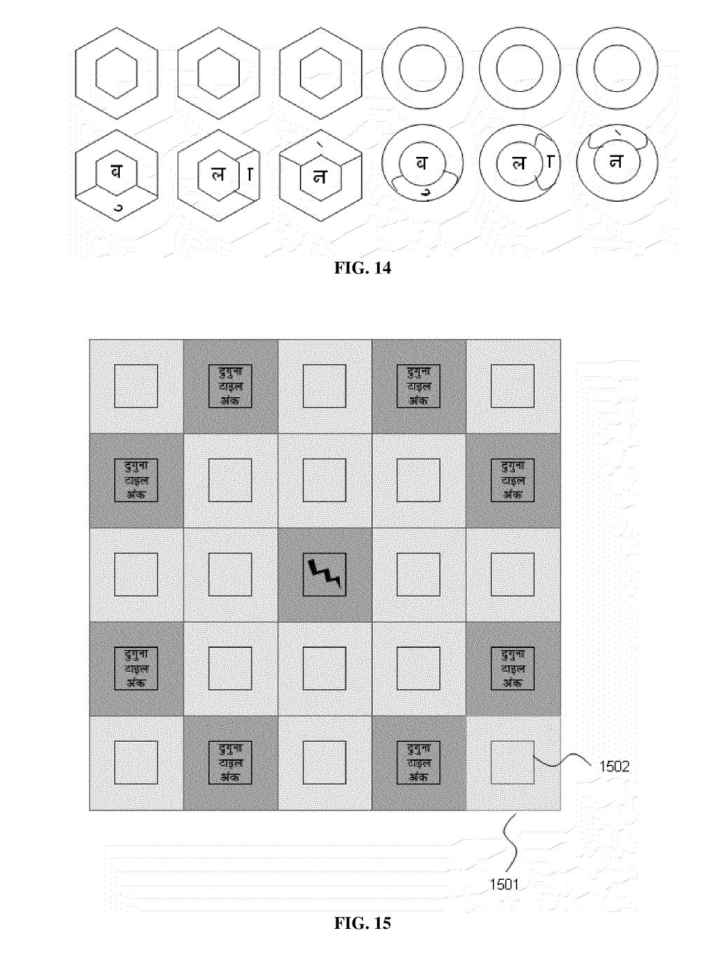

In this preferred embodiment, the invention provides a structured means to house the building blocks representing individual character components of alphasyllabaries, said means comprising of a plurality of spaces, with each space comprising a square within a square, where both the squares are concentric, and the width of the area between the inner square and the outer square is same as the width of the building blocks representing the dependent characters (FIG. 13A). FIG. 13B shows building blocks described in the first embodiment organized in the said means according to the morphological rules of the script. Each space is capable of housing a simple syllable or a complex syllable, similar to the way each cell in a crossword puzzle functions, so as to always maintain orthographic accuracy and conformity with the alphabetic-syllabic nature of the scripts. The inner square typically houses a simple syllable (vowel or consonant), and the area between the inner square and the outer square houses the dependent characters (vowel and/or consonantal diacritics).

The square shape should not be construed in a limiting sense. For instance, the square could very well be another closed shape such as a hexagon or a circle (FIG. 14). These other closed shapes would house building blocks of relevant shapes, as described in FIGS. 12 B, C of the first embodiment.

### A Game Board-Based Word Game

The game board comprises contiguous playing spaces, a limited view of which is illustrated in FIG. 15. Each space comprises of an outer square 1501 and an inner square 1502 as shown in the figure. The main tiles are preferably placed in the inner square 1502 and the special tiles (Maatraa, Ardhaakshar, and if required, reserve tiles) are placed in the space between the inner square and the outer square. The standard written form of Hindi is maintained by placing the special tiles in appropriate positions relative to the main tile. The placement of the special tiles on the board by maintaining the standard written form is illustrated by means of examples.

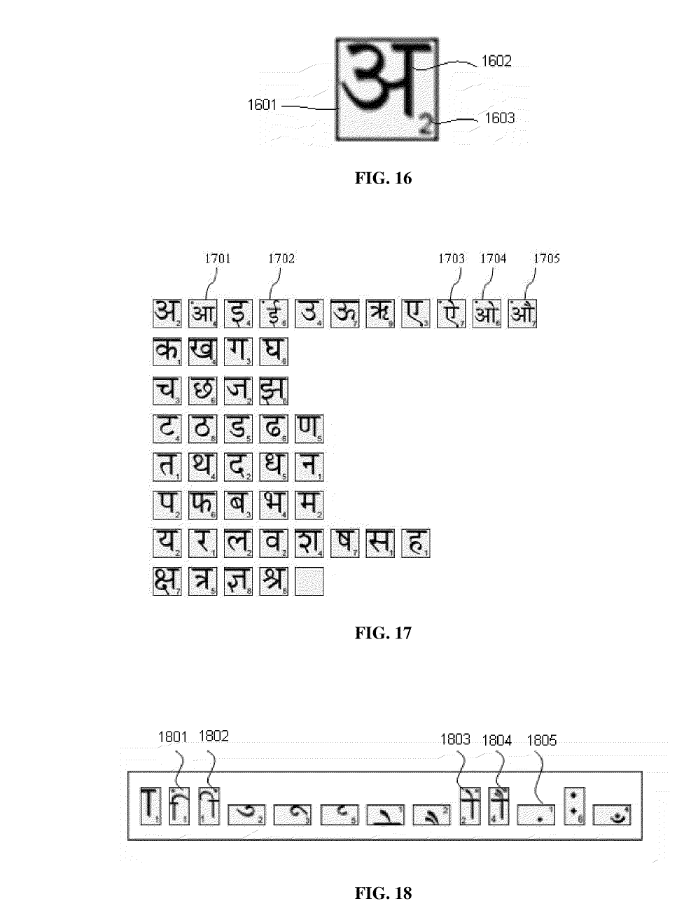

Total word forming and word building in Hindi and other alphabetic-syllabic languages is enabled by using tiles of assorted shapes. Each of the tiles contains a character and the appropriate points allotted to it. The following examples illustrate such tiles used in the case of Hindi. FIG. 16 illustrates an example of the tile used in the game, tile 1601 contains the character 1602 with 2 points, 1603 as indicated in the right bottom corner of the tile 1601.

### Main Tiles

FIG. 17 illustrates the main tiles wherein some of the Svars and Vyanjans of the Hindi alphabets are characterized. The appropriate points for each of the tiles are given at the bottom right corner as shown in FIG. 16. In FIG. 17, 1701 indicates a tile containing an asterisk in the top left corner which indicates that the tile 1701 should be replaced by another tile which will be described later in the application.

### Special Tiles

Maatraa: FIG. 18 illustrates the Maatraa tiles, the tiles indicated by 1801, 1802, 1803 and 1804 contain an asterisk which indicates that these tiles have to be replaced by other appropriate tiles, described elsewhere. For the purpose of total word forming and word building, the anusvaar, visarg, and chandrabindu are included in the pool of maatraas.

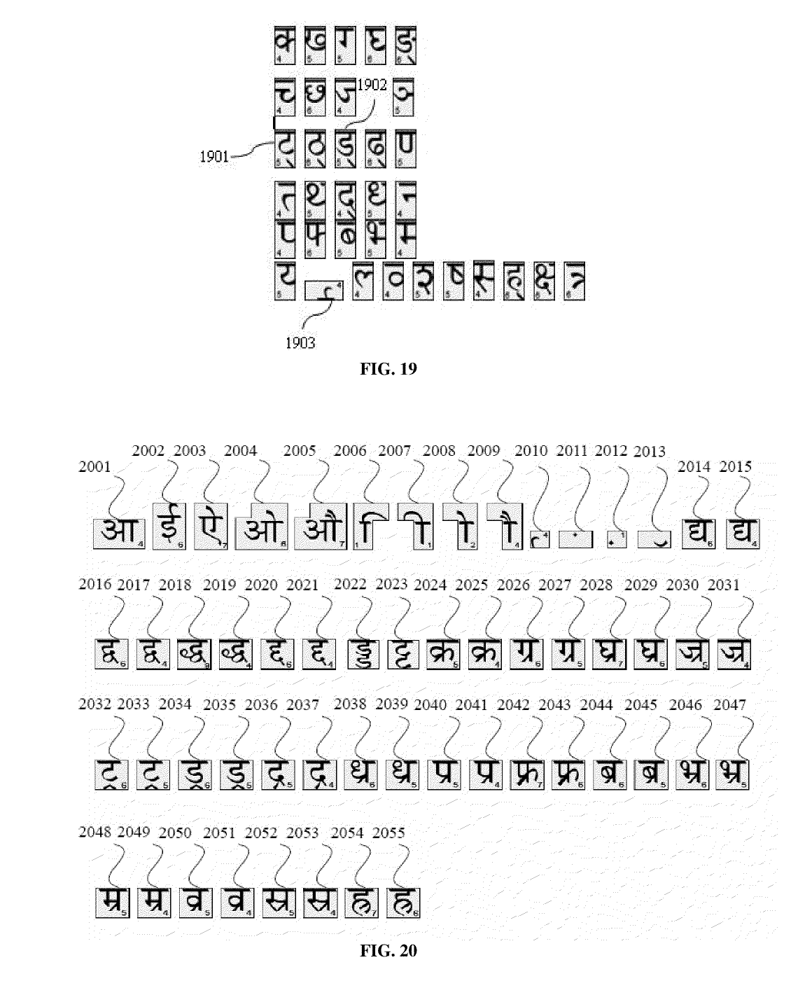

Ardhaakshar: FIG. 19 illustrates the Ardhaakshar tiles. The tiles 1901, 1902 and 1903 can be replaced by Reserve tiles in some instances, examples of which are illustrated elsewhere in the application.

### Reserve Tiles

FIG. 20 illustrates the tiles which are designated as reserve tiles wherein these are used only when their need arises.

In FIG. 20, the tiles 2001, 2002, 2003, 2004, 2005, 2006, 2007, 2008 and 2009 are used to replace 1701, 1702, 1703 1704, 1705, 1801, 1802, 1803 and 1804 respectively. The replacement of the tiles in the described form is done to enable the words formed to achieve orthographic accuracy. The replacement does not alter the functional usage of the said tiles in the words formed.

In FIG. 20, the tile 2010 is used to replace the Ardhaakshar 1903 to enable Total word forming and word building.

In FIG. 20, the tile 2011 is designated as “Neeche bindi”/“Nukta” and is a modifier and does not carry any points. The tile is placed below the main tile according to the morphology of the word formed/built and to achieve orthographic accuracy.

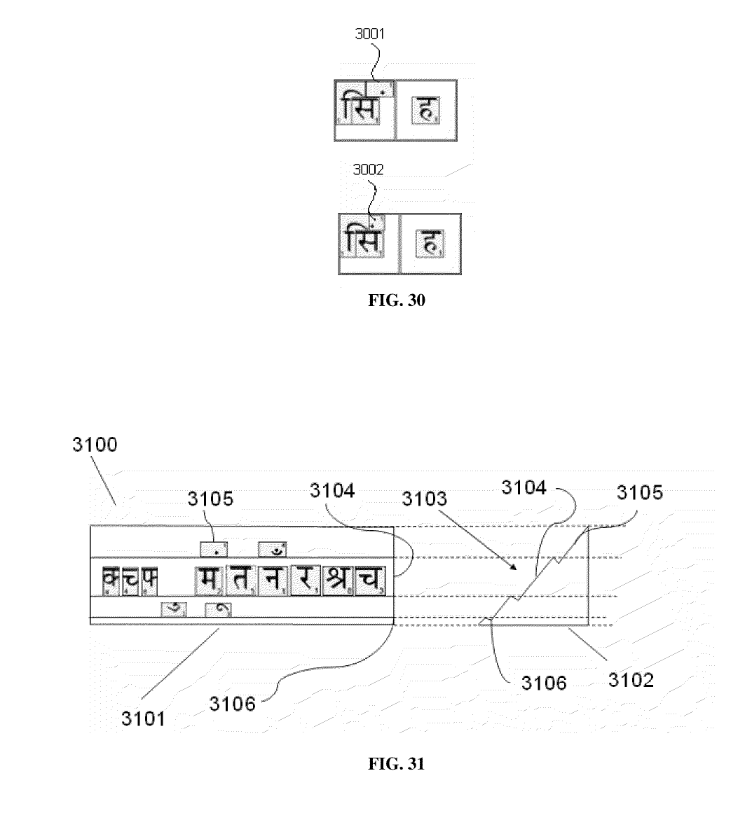

In FIG. 20, the tile 2012 represents the “anusvaar” and is used to replace 1805 to maintain orthographic accuracy. FIG. 30 illustrates a utility for tile 2012.

In FIG. 20, the tiles 2014-2021 represent commonly used “Samyuktaakshars” in the written form. The players have to exchange two tiles that comprise the individual components of the Samyuktaakshar. The tile with appropriate points should be exchanged with the two tiles, for example if regular tiles are exchanged, tile 2014 with 6 points is appropriate; but if the Main tile is blank, then the tile 2015 with 4 points is deemed appropriate. The tiles 2024-2055 represent conjunct consonants, each of which will replace two tiles that comprise the individual components of the conjunct consonant. The tile with appropriate points should be exchanged with the two tiles, for example if regular tiles are exchanged, tile 2024 with 5 points is appropriate.

FIG. 20A illustrates an example for the exchange of tiles; the tiles 2075 and 2076 are replaced by the reserve tile 2018 as shown in the figure.

In FIG. 20, the tiles 2022 and 2023 replace 1902 and 1901 whenever appropriate according to the standard script.

### Word Formation

The first player forms a word either across or down by using any combination of main tiles and special tiles from the tiles that s/he draws, and must occupy at least two spaces, including the center space (depicted by the lightning sign). Tiles cannot be placed in contiguous spaces that are diagonal to each other.

All the tiles played in one turn must be placed in a single row or column either across or down the board.

### Blank Tiles

Each of the four main blank tiles can be used as any main tile. When playing a blank, the player must state what main tile it represents, after which it cannot be changed till the end of the game.

### Permitted Words

Any word from standard Hindi dictionaries is permitted; the dictionary can be consulted only to check the spellings or usage. Foreign words that have been absorbed into the Hindi lexicon are permitted. Some of the exceptions to the permitted words include proper nouns, abbreviations, hyphenated word groups, prefixes and suffixes.

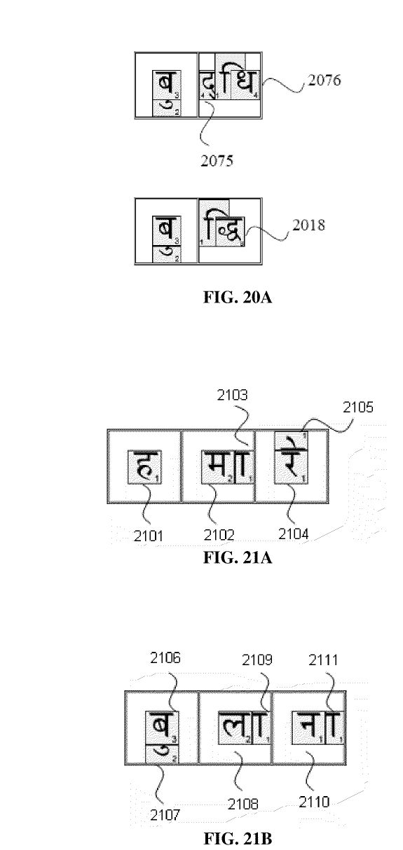

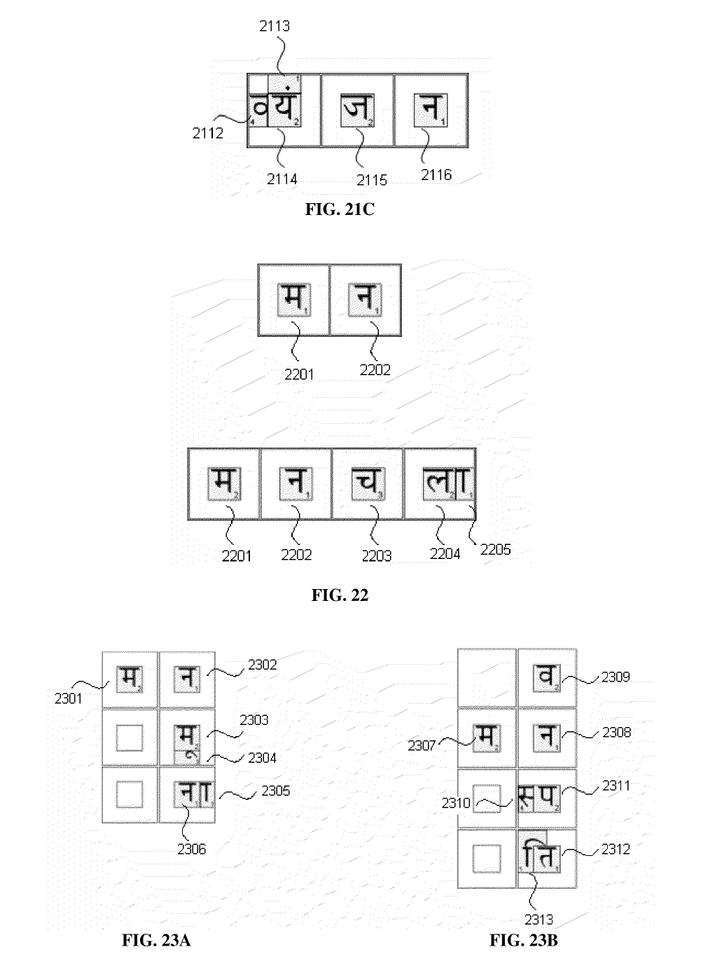

FIGS. 21 A, B and C illustrate word forming by means of examples wherein the different tiles provided are used to form words in the standard written form.

FIG. 21A illustrates the formation of a valid word where 2101 is a main tile with 1 point which is placed in the inner square, 2102 is a main tile with 2 points which is placed in the inner square, 2103 is a Maatraa tile with 1 point which is placed beside the main tile 2102 according to the morphological rules of the script, 2104 is a main tile with 1 point which is placed in the inner square. 2105 is a Maatraa tile with 1 point as indicated in the top right corner of the tile and placed above the main tile 2104 according to the morphological rules of the script.

FIG. 21B illustrates yet another example of word formation where 2106, 2108 and 2110 are main tiles. Tiles 2107, 2109 and 2111 are Maatraa special tiles placed in the space between the main tile and the outer square in the position according to the morphological rules of the script.

FIG. 21C illustrates yet another example wherein the 2114, 2115 and 2116 are main tiles placed in the inner square. 2112 is an Ardhaakshar and placed to the left of the main tile 2114 that it is associated with. 2113 is a Maatraa tile which is placed above 2114 according to the morphological rules of the script

### Game Setup

The game is played by forming and building words using various tiles. There are main tiles wherein the tiles are square shaped, the main tiles include blank tiles which are not allotted any points. The Main tiles are kept in a “Main” bag. There are Special tiles that are rectangular in shape and that include Maatraa tiles (shown in FIG. 18) that are kept in a “Maatraa” bag and Ardhaakshar tiles (shown in FIG. 19) that are kept in the “Ardhaakshar” bag. The game further provides Reserve tiles that include tiles of assorted shapes. The reserve tiles are shown in FIG. 20 and are kept aside and used only when the play warrants their use. Each player is provided with a tile rack as shown in FIG. 31. The game further comprises of the Game Board, a portion of which is as shown in FIG. 15.

### Game Play

In another aspect of the invention, the game play is given. It is preferred that the maximum number of players in the game is 4. Players each draw a tile from the Main bag and the player who draws the tile closest to the first svar will begin the play.

Each player draws a suggested number of tiles from the bags: 8 from the Main bag, 5 from the Maatraa bag and 4 from the Ardhaakshar bag. Each of the players is allotted a tile rack wherein s/he arranges the tiles drawn by in a manner convenient to him/her. The tile rack has three inclined “shelves” as illustrated in FIG. 31 that can accommodate the tiles.

The words are formed on the game board as illustrated by the examples in FIGS. 21 A, B and C and by using the word formation rules as described hereinabove. A player's turn is completed by counting and announcing the score for the turn. At the end of a turn, the players draw as many new tiles from each of the tile bags as they have exhausted in their turn of the game thereby maintaining the initial number of tiles in the preferred combination from each of the tile bags. This method of replacing the tiles exhausted can be achieved until there are enough tiles in the bags.

The play passes to the subsequent players as determined by the order of play at the beginning. All the players should form at least one new word by adding one or more tiles to the tiles already existing on the board. The tiles placed by each of the players must form one complete word and if at the same time the spaces that house the tiles are next to other occupied spaces in adjacent rows or columns, they must form valid words with such spaces. The player is allotted appropriate points for every new word formed by the tiles placed by him or her.

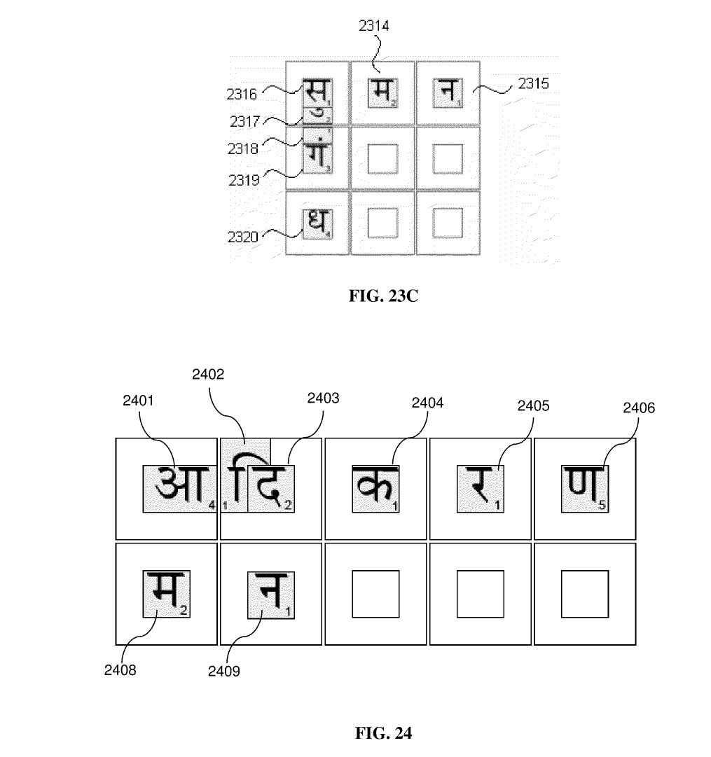

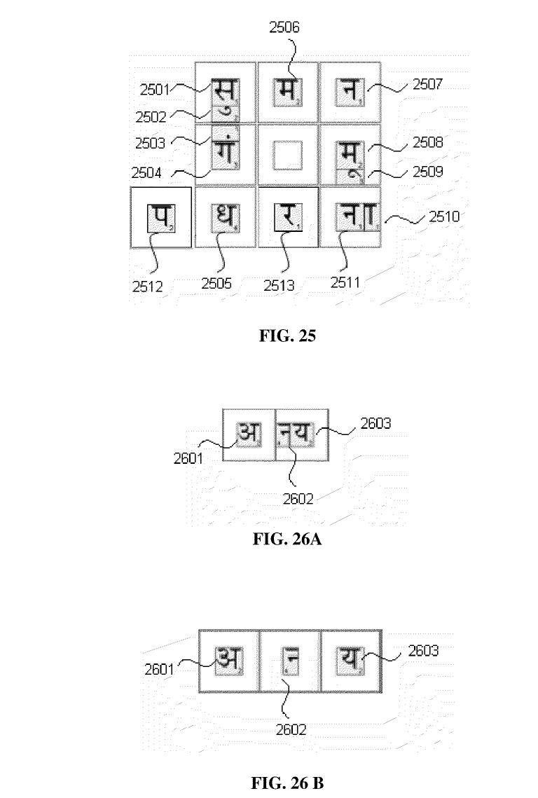

Some of the methods of forming new words are illustrated below with examples:
1. FIG. 22 illustrates an example wherein tiles are added to the end of an existing word to form another complete word. Tiles 2201 and 2202 are tiles already placed on the board and form a complete word, a subsequent player places the tiles 2203, 2204 and 2205 to build a new valid word. The new tiles can be added to the existing tiles including but not limited to the end of the existing tiles, the beginning of the existing tiles, the middle of the existing tiles or a combination of locations as mentioned.
2. A player can form a new a word by placing the tiles perpendicular to the existing word on the board.
   a. An existing tile can be the first tile of the new word as illustrated in the FIG. 23A. Tiles 2301 and 2302 form a valid word already existing on the board; a subsequent player can place the tiles 2303, 2304, 2305 and 2306 to build a new word wherein the tile 2302 is the first character of the said new word.
   b. An existing tile can be somewhere in the middle of the new word as illustrated in the FIG. 23B. Tiles 2307 and 2308 form a valid word already existing on the board, a subsequent player can place the tiles 2309, 2310, 2311, 2312 and 2313 and build a new valid word wherein the existing tile 2308 is a part of the new word as shown in the figure.
   c. A whole word can be attached to an existing word to build two new words in perpendicular direction thus earning the player points for two new words created as illustrated in the FIG. 23C. The tiles 2314 and 2315 form a valid word already existing on the board, a subsequent player places a whole word comprising of 2316, 2317, 2318, 2319 and 2320 as shown in the figure to build two new words, one in the horizontal direction comprising of the existing tiles 2314 and 2315 and the new tiles 2316 and 2317 and the other in the vertical direction wherein both 2316 and 2317 form a part thereof.
3. A player can place tiles parallel to an existing word, but the new tiles should form new words in the perpendicular direction with the existing tiles as illustrated in the FIG. 24. The tiles 2408 and 2409 form a valid word and exist on the board. A subsequent player can place 2401-2406 in an adjacent row as shown in the figure, but the word placed must form valid words with the adjacent spaces of the existing word. In the figure the tiles 2401 and 2408 form a valid word; and 2402, 2403 and 2409 form a valid word.
4. A player can link two words which are parallel to each other by placing the tiles in a perpendicular direction to the existing parallel words as illustrated in the FIG. 25. The figure demonstrates a situation wherein there are three words existing on the board: 2501-2505; 2501, 2502, 2506, and 2507; and 2507-2511. A player can place tiles perpendicular to both the columns 2501-2505 and 2507-2511 as shown by 2512 and 2513.

### Locking of Tiles

The tiles of valid words placed on the board are locked to their position and cannot be replaced.

### Scoring

The score for each turn is the sum of all the tile values in each word formed or built in the play, plus bonus points resulting from tiles placed on bonus spaces on the game board, plus any additional bonus points based on the length of the word formed or built.

### Placement of Tiles

Placement of Ardhaakshar: The players have the option of placing the Ardhaakshar in a separate space preceding the space which contains the associated main tile as illustrated by the example in FIG. 26.

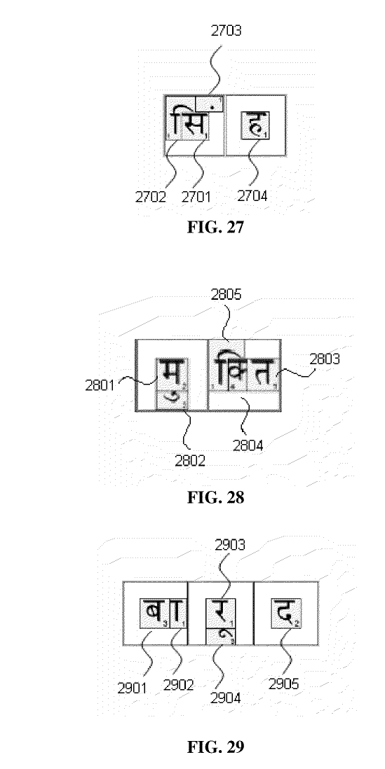

Variation in the placement of maatraas: Sometimes, when special tiles are used as is, the word formed is not an accurate representation of the written form, as illustrated in FIG. 27. In the figure, the tile 2703 is placed on the top right of the main tile 2701, but is further right than required by the script.

Variation in the placement of main tile: In exceptional cases, it might be best to place the main tile in a position other than the inner square to enable all the tiles associated with the main tile to remain within the confines of the space, as shown in FIG. 28. In the figure the main tile 2803 is moved to the right, away from its regular location (inner square) to accommodate 2804 and 2805, both of which have to be placed to the left of the main tile according to the script.

Exceptions to written form: Exceptions where the placements of the tiles do not exactly reflect the written form are illustrated by means of examples in FIG. 29. In the figure, the tile 2904 is placed at the bottom of the main tile 2903, but in the standard written format, the character in 2904 is attached to the main character in the main tile 2903. It must be noted that such exceptions are still logically correct.

Exchanging of special tiles: FIG. 30 illustrates an example wherein the Maatraa tiles are exchanged. The Maatraa tile 3001 is exchanged with the tile 3002 that has the same function but is of a more appropriate shape in the context of the word, contributing to orthographic accuracy.

FIG. 31 shows the front view (3101) and side view (3102) of the rack. The angle of view towards the rack is shown by arrow 3103. Players may choose to arrange the tiles as they deem fit. In the figure, the main tiles are placed in the center rack (3104) along with the ardhaakshars. Some maatraas are placed in the upper rack (3105) and some maatraas are placed in the lower rack (3106).

### A Frame-Based Word Building Educational Apparatus

In another embodiment of the invention, there is provided an apparatus in the form of a frame consisting of a rectangular or square grid of “spaces” in the form of slots, where tiles representing individual character components could be placed in a manner so as to form words. Each space comprises of an outer square and a guide in the interior that indicates the preferred position of the main tile. The main tile is intended to be placed against the guide in the interior and the special tiles are intended to be placed in the gap between the main tile and the outer square.

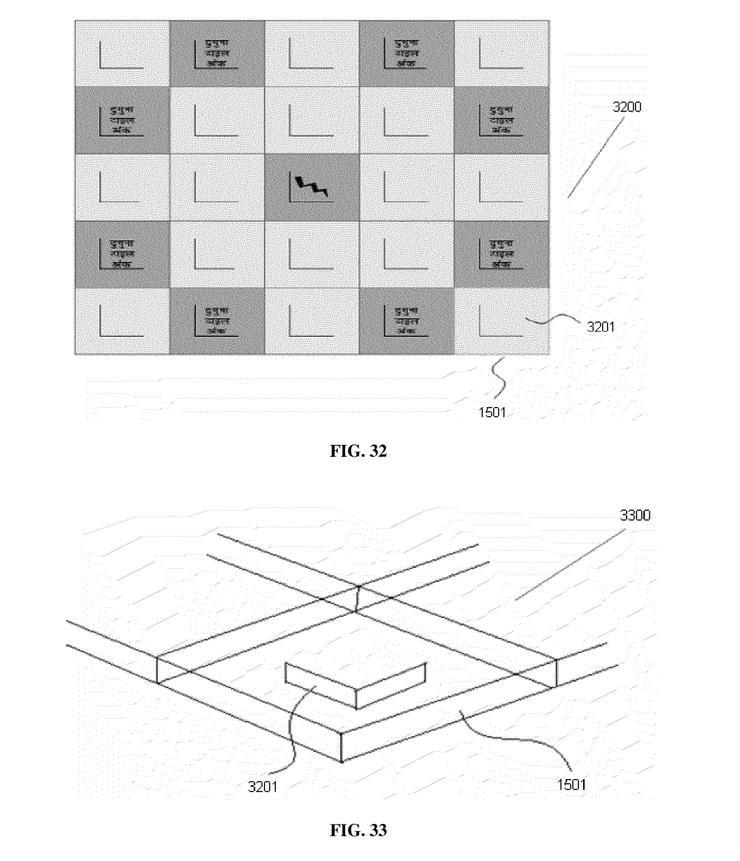

FIG. 32 shows the apparatus used for easy placement of tiles using a guide. It shows the outer square (1501) inside which an L-shaped guide (3201) is present. This guide can be used by the user to place the main tile and to position the ardhaakshars, reserve tiles and matraas in the gap between the main tile and the outer square. This L-shaped guide (3201) is present in all the spaces of the grid.

FIG. 33 shows the three-dimensional view of one space of the apparatus used for easy placement of building blocks using L-shaped guides in the interior.

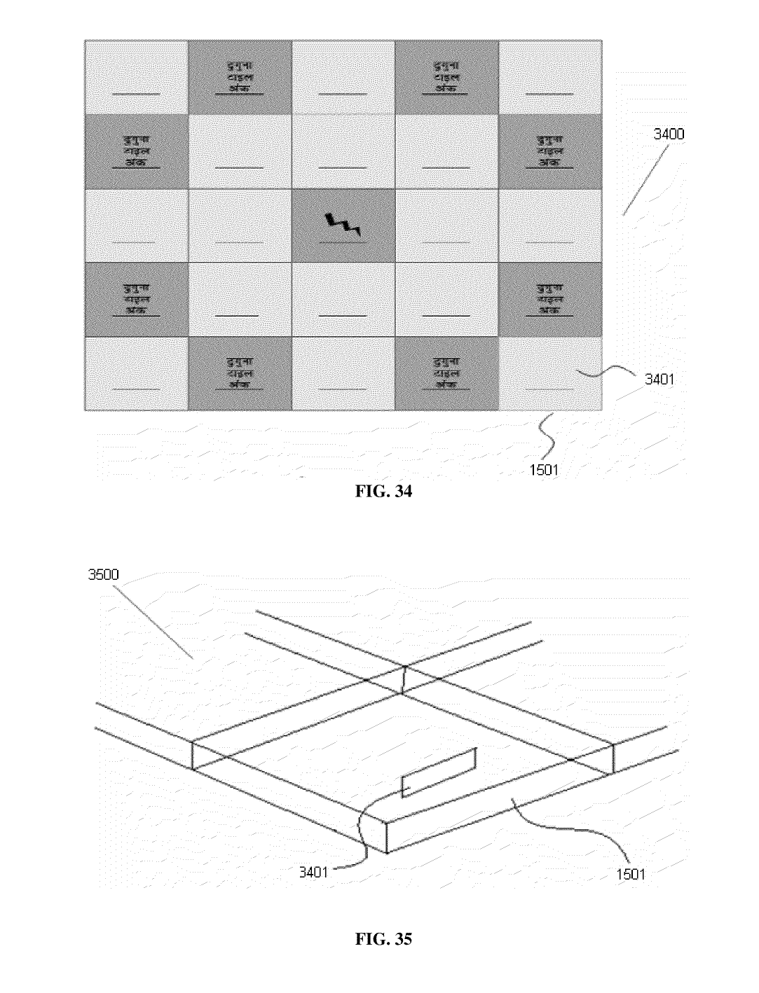

FIG. 34 shows another embodiment for an apparatus used for easy placement of tiles. It shows the outer square (1501) inside which a straight line guide (3401) is present. This guide can be used by the user to place the main tile and to position the ardhaakshars, reserved tiles and maatraas in the gap between the main tile and the outer square. This straight line guide (3401) is present in all the spaces of the grid.

FIG. 35 shows the three-dimensional view of one space of the embodiment for easy placement of building blocks using a straight line guide in the interior.

A teacher can demonstrate various words and their formations by placing the tiles in the frame accordingly. The teacher can get the students to participate in forming and placing new words on the frame, or by displacing or removing maatraas and/or ardhaakshars from existing words on the frame to form new words. The teacher and the students can also experiment with various possibilities to form and connect words in geometric patterns such as polygons or crossword puzzles.

### A Simple Word Building Game

In one another embodiment, the invention provides an apparatus in the form of a contraption that has 3 to 8 spaces (slotted) adjacent to each other in a single row for forming words. Each space comprises of a guide that indicates the preferred position of the main tile. The main tile is intended to be placed in the interior of the space and the special tiles are intended to be placed in the gap between the main tile and the outer square.

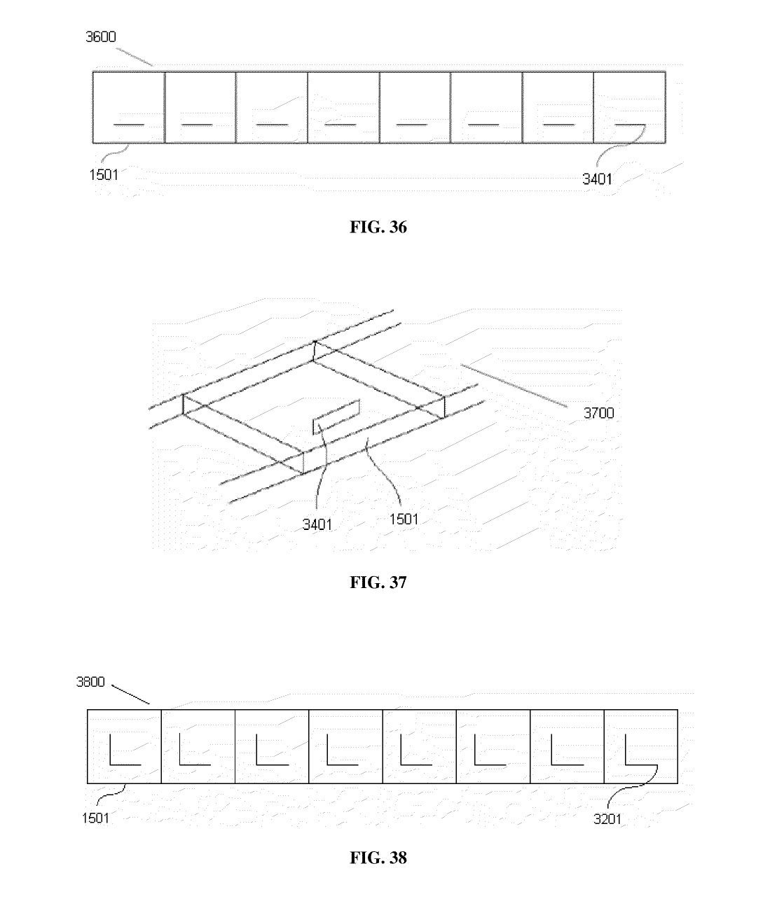

FIG. 36 shows a contraption that has 8 spaces adjacent to each other in a single row for forming words. Each space (1501) comprises of a straight line guide in the interior that indicates the preferred position of the main tile. This guide can be used by the user to place the main tile and to position the ardhaakshars, reserve tiles and matraas in the gap between the main tile and the outer square.

FIG. 37 shows the three dimensional view of a single space—an outer square (1501) along with a straight line guide (3401) in the interior for easy placement of letters.

FIG. 38 shows a contraption that has 8 spaces adjacent to each other in a single row for forming words. Each space (1501) comprises of an L-shaped guide in the interior that indicates the preferred position of the main tile. This guide can be used by the user to place the main tile and to position the ardhaakshars, reserve tiles and matraas in the gap between the main tile and the outer square.

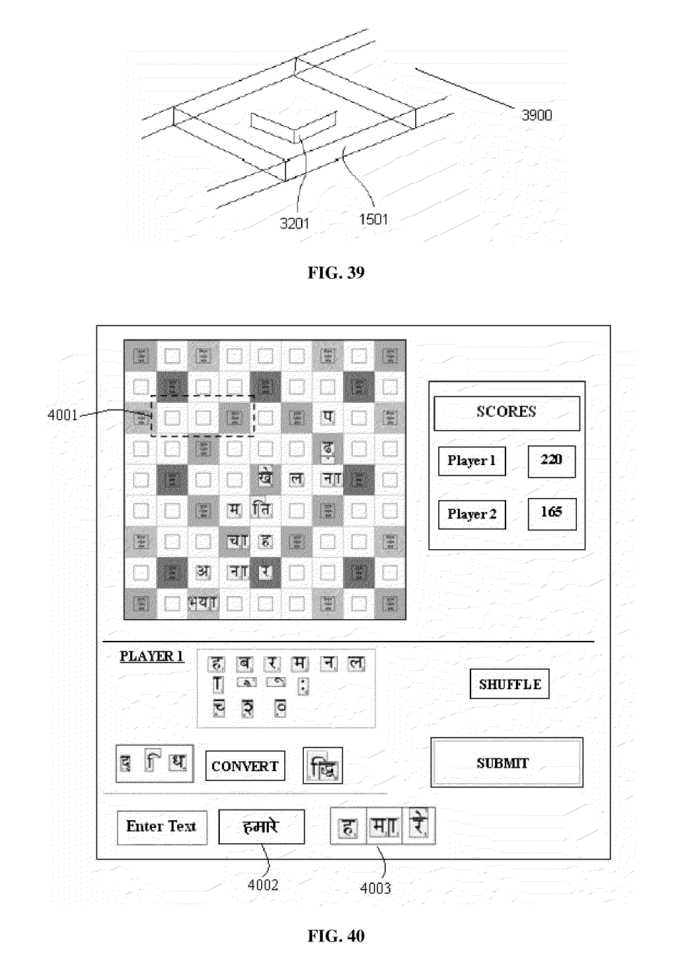

FIG. 39 shows the three dimensional view of a single space—an outer square (1501) along with an L-shaped guide (3201) in the interior for easy placement of letters.

The game play involves players each drawing a combination of main tiles (x), maatraas (y), and ardhaakshars (z). Each player submits a word with his/her tiles within a given time limit for each round. The score for a word submitted is based on the points on the tiles and the length of the word formed (more points for longer words). Each player then draws the appropriate number of tiles from the bags so as to maintain the pre-decided x+y+z combination. The players can decide the number of rounds to play, after which the points are totaled and the player with the maximum number of points wins.

### Another Simple Word Building Game

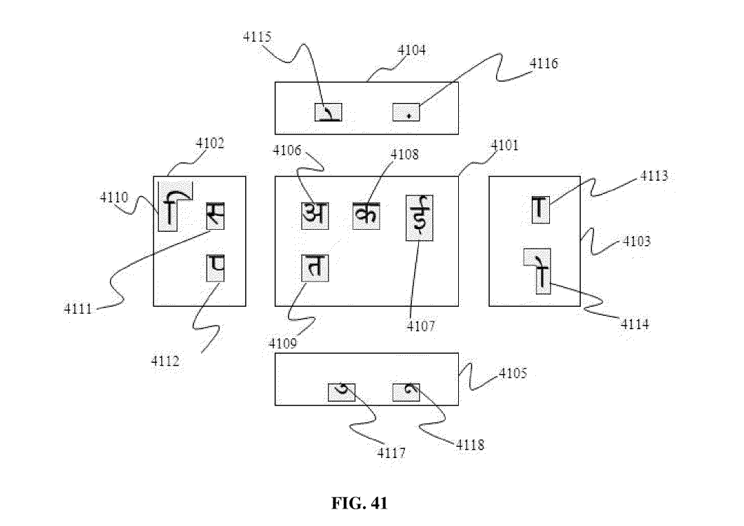

In one another embodiment, the invention provides an apparatus/method of display in the form of five “zones”—centre, left, right, top and bottom—to which these individual script components are assigned to, based on the position they occur in the script, relative to the vowel or consonant they are associated with. FIG. 41 illustrates an example: Vowels/consonants such as [symbol] and [symbol] (4106, 4107, 4108, 4109 respectively) are assigned to the centre zone 4101; the [symbol] maatraa (4110) and half consonants such as [symbol] and [symbol] (4111 and 4112 respectively) are assigned to the left zone 4102; maatraas such as [symbol] and [symbol] (4113 and 4114 respectively) are assigned to the right zone 4103; script components such as [symbol] and [symbol] (4115 and 4116 respectively) are assigned to the top zone 4104; and script components such as [symbol] and [symbol] (4117 and 4118 respectively) are assigned to the bottom zone 4105.

### Other Display Systems

The foregoing discussion was based on physical display means to display characters of, and word forming and word building apparatus for Hindi and other alphabetic-syllabic languages while maintaining the orthographic accuracy of the scripts and conforming to the alphabetic-syllabic nature of the language scripts.

However, the present invention is as much applicable to virtual display means as it is to physical display means. Now, referring to FIG. 40, a virtual interface of the game is represented, where the aforementioned embodiments can be hosted on a variety of electronic platforms and gadgets, such as computers, Internet, mobile phones, television sets, and hand held video games, through which users can interact with the devices or with each other through the devices. The virtual display means may include but is not limited to computer monitors, television monitors, LCD monitors, projection systems, portable display devices, and game console display devices. Furthermore, it will be obvious to a skilled person in the art that the representation of alphasyllabaries as described herein may be constructed in a variety of media. The media that may be used to construct representations as described herein may include any appropriate digital media. The digital media may be computer readable media that may include but are not limited to computer readable media, comprising instructions for construction of representation of alphasyllabaries, like volatile memory devices including hard disks, non-volatile memory devices including flash memory devices, microcontrollers, programmable logic devices, and electronic signals through a communication medium like Internet and various other telecommunication network media. FIG. 40 shows an example of the electronic manifestation of the game wherein various aspects of the game including but not limited to the scores of the players, the blocks available with a player are shown. Further, there is provided a method to convert individual components of a conjunct consonant into an accepted form of a conjunct consonant. Further, there is provided a method to select spaces 4001 wherein the player wishes to enter the blocks of the word and to enter the text in the provided space 4002 and submit the same; wherein the submitted word which is verified for accuracy by the software is converted to corresponding blocks and shown in the selected spaces 4001. Further, there is provided a method wherein the player can arrange the blocks in the linear grid 4003 and then submit the word for the spaces 4001 by selecting the submit option or dragging and dropping the blocks onto the virtual game board; the linear grid 4003 is cleared of existing blocks after submission. One skilled in the art would easily appreciate the fact that the interface may be enabled and/or supported by a software system or a hardware system or a system combining elements of software and hardware or an embedded system, where possible software components may be located on a program readable memory.

Although the invention has been described with reference to specific embodiments, this description is not meant to be construed in a limiting sense. Also, the embodiments can be represented in various media (electronic and print). The building blocks can easily be adapted to have magnetic inserts allowing for use with a metallic base frame, game board or contraption on which words can be formed/built. Various modifications of the disclosed embodiments, as well as alternate embodiments of the invention, will become apparent to persons skilled in the art upon reference to the description of the invention.

### APPENDIX A

### Characters Used in the English Language (Latin Script)

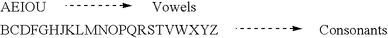

### Characters Used in the Hindi Language (Devanagari Script)

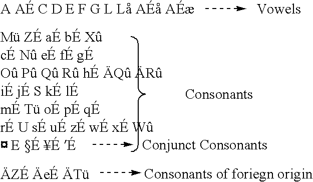

É Í [symbol] Ñ Ô×å æÉå üÉæ [symbol] ü È [symbol] ü [symbol] --→Vowel diacritics (allographs of vowels) and vowel modifiers (last three characters)

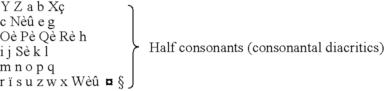

What is claimed is:

1. A method of displaying alphasyllabaries by way of building blocks representing individual character components of the scripts, the method comprising:
a. representing each independent vowel and consonant, and conjunct consonant that is part of the “alphabet” on a building block of plurality of sides;
b. representing each of the accepted forms of conjunct consonants on a building block of plurality of sides; and
c. representing dependent characters comprising vowel, consonantal and other diacritics using building blocks of appropriate shapes,
where the building blocks enable orthographic accuracy of the words formed in relation to the script and conformity with the alphabetic-syllabic nature of the scripts.

2. A method as in claim 1, where number of sides is 4.

3. A method as in claim 1, where number of sides is infinity, meaning the block is circular in shape.

4. A method as in claim 1, where the building block representing each vowel, consonant, conjunct consonant that is part of the “alphabet”, and accepted form of conjunct consonant is square shaped, rectangular shaped, or of a shape that results from cropping a portion of the square or rectangular shape.

5. A method as in claim 1, where diacritics, occurring only in one of the four zones (before, after, above, or below) in relation to the consonants they are associated with, are represented by building blocks that are confined to the respective zones of the diacritics.

6. A method as in claim 5, where each diacritic is displayed by a rectangular-shaped building block.

7. A method as in claim 1, where diacritics occurring in more than one of the four zones (before, after, above, and below) in relation to the consonants they are associated with are represented by building blocks that spread across two or more zones.

8. A method as in claim 7, where diacritics spreading across two adjacent zones are represented by an L-shaped building block.

9. A method as in claim 7, where diacritics spreading across three adjacent zones or two opposite zones are represented by a U-shaped building block.

10. A method as in claim 1, where the method comprises displaying alphasyllabaries in a structured manner where a structured means to place the building blocks in to form words is provided, said means comprising a plurality of spaces with each of the said spaces being a closed shape within a closed shape, with the inner closed shape accommodating an independent vowel or consonant, a conjunct consonant that is part of the “alphabet”, or an accepted form of conjunct consonant, and the area between the inner closed shape and the outer closed shape of width being equal to the width of the building blocks representing dependent characters.

11. A method as in claim 1, where said display is on an electronic display device.

12. A method as in claim 1, where said display is on a print medium.

13. An apparatus for (total) word forming and word building in alphasyllabaries, the apparatus comprising of:
a. a means to place tiles to form and/or build words comprising of a string of simple syllables and/or complex syllables, said means comprising of a plurality of spaces with each of the said spaces being a closed shape within a closed shape; and
b. a set of main tiles representing independent vowels or consonants or conjunct consonant that are part of the “alphabet” to be placed in the inner closed shape of the said spaces; and
c. a set of special tiles representing dependent characters comprising vowel diacritics, vowel modifiers and consonantal diacritics to be placed in the area between the inner closed shape and outer closed shape,
where orthographic accuracy and conformity with the alphabetic-syllabic nature of the scripts are achieved by assigning the individual language character components (such as consonants, vowels, and diacritics) to appropriately shaped building blocks and placing these building blocks in a sequence or grid of spaces, with each space providing an area between the inner closed shape and the outer closed shape to accommodate building blocks representing dependent characters, with the width of the area being equal to the width of the building blocks representing dependent characters.

14. An apparatus as in claim 13, where each space accommodates a simple syllable or a complex syllable, with said simple syllable or complex syllable comprising building blocks representing any or a combination of a consonant, an independent vowel, a diacritic, or an accepted form of a conjunct consonant.

15. An apparatus as in claim 13, where said means to place tiles is a game board comprising a plurality of spaces for forming and building words.

16. An apparatus as in claim 15, where said means to place tiles is a game board consisting of a 15×15 spaces grid (and therefore 225 spaces) for forming and building words.

17. An apparatus as in claim 13, where said means to place tiles is a frame or game board comprising a plurality of spaces in the form of a grid for forming and building words, the spaces being in the form of slots.

18. An apparatus as in claim 15, where a combination of simple and/or complex syllables forms words in both horizontal and vertical directions on said board.

19. An apparatus as in claim 13, where said means to place tiles is a frame/contraption having a plurality of spaces in a linear fashion for forming words, the spaces being in the form of slots.

20. An apparatus as in claim 17, where said frame or game board comprises a 15×15 spaces grid.

21. An apparatus as in claim 19, where the number of spaces on the frame/contraption ranges from 3 to 8.

22. An apparatus as in claim 17, where each space has a guide in the interior that coincides with the left and bottom portion of the inner closed shape of the closed shape-within-a-closed shape arrangement, and where the inner closed shape may or may not be explicitly marked.

23. An apparatus as in claim 19, where each space has a guide in the interior that coincides with the left and bottom portion of the inner closed shape of the closed shape-within-a-closed shape arrangement, and where the inner closed shape may or may not be explicitly marked.

24. An apparatus as in claim 22, where each space has an L-shaped guide in the interior in a position coinciding with two sides of the inner closed shape of the closed shape-within-a-closed shape arrangement, and where the inner closed shape may or may not be explicitly marked.

25. An apparatus as in claim 17, where each space has a guide in the interior that coincides with a portion of the inner closed shape of the closed shape-within-a-closed shape arrangement, and where the inner closed shape may or may not be explicitly marked.

26. An apparatus as in claim 19, where each space has a guide in the interior that coincides with a portion of the inner closed shape of the closed shape-within-a-closed shape arrangement, and where the inner closed shape may or may not be explicitly marked.

27. An apparatus as in claim 13, where the apparatus further comprises a rack, the rack being a multi-level rack to place and manage the tiles while forming and building words.

28. An apparatus as in claim 13, where the main tiles have plurality of sides each, where number of sides ranges from 4 to infinity.

29. An apparatus as in claim 13, where the main tiles are square shaped, rectangular shaped, or of a shape that results from cropping a portion of the square or rectangular shape.

30. An apparatus as in claim 13, where the special tiles are rectangular in shape.

31. An apparatus as in claim 13, the apparatus further comprises reserve tiles of assorted shapes for replacing certain special tiles to contribute to “total” word forming and word building.

32. An apparatus as in claim 31, where tiles representing diacritics that spread across two adjacent zones are L-shaped.

33. An apparatus as in claim 31, where tiles representing diacritics that spread across three adjacent zones or two opposite zones are U-shaped.

34. An apparatus as in claim 31, where vowels are rectangular in shape, of a size up to the combination of a square-shaped main tile and a rectangular-shaped special tile.

35. An apparatus as in claim 31, where the nuktaa/neeche bindi is rectangular in shape and enables modification of a consonant to a more appropriate sounding consonant, as required by the word formed or built.

36. An apparatus as in claim 31, where a building block that occupies the top right portion of the area between the inner closed shape and outer closed shape has a depression.

37. An apparatus as in claim 31, where the building blocks representing the diacritics “II”, “O”, and “AU”, and the building blocks representing the vowels “O” and “AU” in Devanagari, Gurmukhi, and Gujarati scripts each have a depression.

38. An apparatus as in claim 31, where the anusvaar diacritic in Devanagari, Gujarati, and Gurmukhi is a tiny squared building block.

39. An apparatus as in claim 31, where the half consonant of “RA” in Devanagari, Gujarati, Gurmukhi, and Bengali is a tiny squared building block.

40. An apparatus as in claim 31, where tiles are of a shape that results from cropping a portion of a square or rectangular shape.

41. An apparatus as in claim 31, where the vowels “O” and “AU” in Devanagari are of a shape that results from cropping a portion of a square or rectangular shape.

42. An apparatus as in claim 13, where the frequency distribution of the building blocks depicting consonants, maatraas, and ardhaakshars is specific to the invention and is largely similar to the frequency distribution of corresponding characters found in common publications such as newspapers and magazines.

43. An apparatus as in claim 13, where each of special tiles, main tiles, and reserve tiles has associated points represented on the tile.

44. A method of constructing alphasyllabaries by way of building blocks representing individual character components of the scripts, the method comprising:
a. providing a building block of plurality of sides for each independent vowel and consonant, and conjunct consonant that is part of the “alphabet”;
b. providing a building block of plurality of sides for each of the accepted forms of conjunct consonants; and
c. providing building blocks of appropriate shapes for dependent characters comprising vowel, consonantal and other diacritics,
where the building blocks enable orthographic accuracy of the words formed in relation to the script and conformity with the alphabetic-syllabic nature of the scripts.

45. A method as in claim 44, where said construction is performed on a digital media.

46. A method of displaying the individual components of scripts in five zones—centre, left, right, top and bottom—to which individual script components are assigned to, based on the position they occur in the script, relative to the vowel or consonant they are associated with.
